(19) United States
(12) Patent Application Publication
(10) Pub. No.: US 2024/0130002 A1
(43) Pub. Date: Apr. 18, 2024

(54) TECHNOLOGIES FOR WIRELESS SENSOR NETWORKS

(71) Applicant: Intel Corporation, Santa Clara, CA (US)

(72) Inventors: Rahul Khanna, Portland, OR (US); Yi Qian, Shanghai (CN); Greeshma Pisharody, Portland, OR (US); Raju Arvind, Bangalore (IN); Jiejie Wang, Shanghai (CN); Laura M. Rumbel, Portland, OR (US); Christopher R. Carlson, Beaverton, OR (US); Jennifer M. Williams, Hillsboro, OR (US); Prince Adu Agyeman, Hillsboro, OR (US)

(73) Assignee: Intel Corporation, Santa Clara, CA (US)

(21) Appl. No.: 18/264,214

(22) PCT Filed: Mar. 3, 2022
(86) PCT No.: PCT/US2022/018681

§ 371 Date: Aug. 3, 2023

(30) Foreign Application Priority Data
Mar. 3, 2021 (WO) PCT/CN2021/078933

(51) Int. Cl. H04W 76/40; H04W 12/00; H04W 74/00

(52) U.S. Cl. CPC H04W 76/40; H04W 12/009; H04W 74/006

(57) ABSTRACT

Various technologies relating to wireless sensor networks (WSNs) are disclosed, including, but not limited to, device onboarding and authentication, network association and synchronization, data logging and reporting, asset tracking, and automated flight state detection.

### CROSS-REFERENCE TO RELATED APPLICATION

This patent application claims the benefit of the filing date of International Application No. PCT/CN2021/078933, filed on Mar. 3, 2021, and entitled “TECHNOLOGIES FOR WIRELESS SENSOR NETWORKS,” the contents of which are hereby expressly incorporated by reference.

### TECHNICAL FIELD

This disclosure relates in general to the field of computer networks and sensors, and more particularly, though not exclusively, to various technologies for wireless sensor networks.

### BACKGROUND

A wireless sensor network, which typically includes a collection of sensors connected to a network, may be used for a variety of use cases, such as asset tracking, inventory management, fault detection, and so forth. There are various challenges associated with deploying and maintaining a large-scale wireless sensor network, however, including inefficient and insecure mechanisms for joining or associating with a network, poor battery life, faults (e.g., loss of connectivity, loss of sensor data), inability to verify the integrity or chain of custody or sensor data and assets, and so forth.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates an example embodiment of a wireless sensor network (WSN).

FIG. 2 illustrates signal timing diagrams for a WSN that leverages advertising beacons to enable clients to associate with the network.

FIG. 3 illustrates a flowchart for associating with a WSN using advertising beacons in accordance with certain embodiments.

FIG. 4 illustrates a signal timing diagram for a WSN that leverages assigned contention slots for clients seeking to associate with the network.

FIG. 5 illustrates a flowchart for associating with a WSN using an assigned contention slot in accordance with certain embodiments.

FIG. 6 illustrates a signal timing diagram for a WSN that leverages rapid nano beacons to enable clients to quickly resynchronize with the network after a temporary loss of connectivity.

FIG. 7 illustrates a flowchart for quickly resynchronizing with a WSN using nano beacons after losing connectivity.

FIG. 8 illustrates a signal timing diagram for a WSN that leverages logged data beacons to collect sensor data captured during gaps in connectivity.

FIG. 9 illustrates a flowchart for logging and reporting sensor data captured during gaps in connectivity with a WSN.

FIG. 10A illustrates an example process for secure onboarding of a gateway.

FIG. 10B illustrates an example process for secure onboarding of a sensor tag.

FIG. 10C illustrates an example of a sensor tag join and challenge process.

FIG. 11 illustrates an example of a secure transfer of custody of sensor tags in a WSN.

FIG. 12 illustrates an example sequence flow for performing a secure transfer of custody for a sensor tag.

FIG. 13 illustrates an example implementation of automated takeoff/landing detection using acceleration and pressure data.

FIG. 14 illustrates a process flow for takeoff/landing detection using pressure sensor profiling.

FIG. 15 illustrates a flowchart for autonomously enabling/disabling radio frequency (RF) transmissions on a device onboard an airplane.

FIG. 16 illustrates an example of automated blockchain-based asset tracking and auditing.

FIG. 17 illustrates a flowchart for automated asset tracking and shipment auditing.

FIG. 18 illustrates an overview of an edge cloud configuration for edge computing.

FIG. 19 illustrates operational layers among endpoints, an edge cloud, and cloud computing environments.

FIG. 20 illustrates an example approach for networking and services in an edge computing system.

FIG. 21 illustrates a domain topology for respective internet-of-things (IoT) networks coupled through links to respective gateways, according to an example.

FIG. 22 illustrates a cloud computing network in communication with a mesh network of IoT devices operating as a fog device at the edge of the cloud computing network, according to an example.

FIG. 23 illustrates a drawing of a cloud computing network, or cloud, in communication with a number of Internet-of-Things (IoT) devices, according to an example.

FIG. 24A illustrates an overview of components in a compute node in accordance with certain embodiments.

FIG. 24B illustrates a more detailed overview of components in a compute node in accordance with certain embodiments.

FIG. 25 illustrates an example software distribution platform.

### DETAILED DESCRIPTION

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### Overview of Wireless Sensor Networks

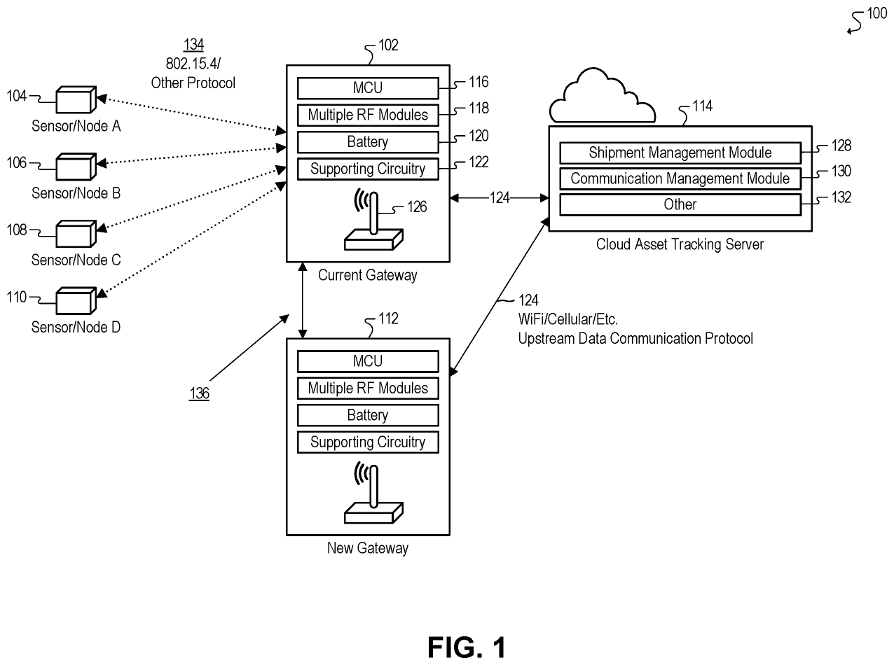

This disclosure presents various technologies and solutions for wireless sensor networks. An example wireless sensor network environment in which these various technologies and solutions may be implemented is shown in FIG. 1.

In particular, FIG. 1 illustrates an example wireless sensor network (WSN) 100. In the illustrated example, WSN 100 includes multiple sensors/nodes 104-110, gateway appliances 102, 112, and a cloud asset tracking server 114. In some embodiments, sensors 104-110 may be associated with, coupled to, and/or integrated within corresponding assets that are tracked or monitored in WSN 100 by gateways 102, 112 and cloud asset tracking server 114. In various embodiments, for example, some or all of the components in WSN 100 may be in a warehouse, truck, rail car, rolling stock, airplane, cargo carrying device or vehicle, drone, or other device where goods are prepared and/or packaged for transit to a destination, are in transit, or have reached a destination.

For the purposes of this description, gateway appliance 102 is designated the “Current Gateway”, i.e., the gateway to which exemplary sensor devices 104-110 are communicatively coupled at the current point in time. In the illustrated embodiment it is assumed devices 104-110 are “Sensors” or “Nodes” assigned to gateway appliance 102 but it will be appreciated other devices may be in communication with the gateway. Regarding terminology, nomenclature allows for referring to the devices by different names, e.g., node, sensor, smart sensor, smart tag, etc.

In asset tracking systems, such as may be included in system 100, nodes 104-110 may be attached or otherwise associated with packages, units of merchandise, or the like, and multiple nodes may be assigned to, and monitored by, gateway appliances 102, 112. As described below, each of the nodes may include various sensors. For the purposes of this description, the term “gateway” includes any device to which a particular node is assigned, even for a short time, as in what is known as an “intermediary” or gateway “proxy” for a node. For example, a warehouse may have various gateways installed, which monitor sensors on packages or pallets of merchandise. When a new shipment comes into the warehouse on a truck, for example, the merchandise in the truck may generally be monitored by, and thus assigned to, a gateway installed on the truck. Once unloaded, it may be that a first portion of the packages in the truck are to be sent onwards to one destination, and a second portion of the packages others to a wholly different one. It may also be that when the truck initially enters the warehouse, the gateways to which each of the first and second portions of packages are to be assigned to for the next leg of their respective journeys may not yet be known, and thus each of the portions may be assigned to a representative or proxy of their actual next gateway, which will subsequently hand them off to the gateway that will monitor them on the next leg of their respective journeys. In some contexts, a node may be known as a “child”, and the gateway to which it is assigned as its “parent.” In a transfer of custody as described below, one or more “children” are advised that they are now in the custody of a new “parent.”

Gateway appliance 102 may be one or more hardware devices and/or one or more software modules and/or any combination of hardware and software that carry out the monitoring and communication with nodes 104-110 in a premise or venue. In embodiments, the one or more hardware devices may be tamper resistant and operations may be carried out independent of processor(s) of a host/application platform. In embodiments where the gateway appliance is implemented as one or more software modules, the software modules may include “enclaves” which may be isolated regions of code and/or data within the memory of a computing platform (e.g., Intel® Software Guard Extension Enclaves). As illustrated, the gateway appliance 102 may coordinate with a second gateway appliance 112, each of which may be assigned zero or more nodes to manage or track at any given time. The description of gateway appliance 112 may be similar or the same as that for gateway appliance 102.

Gateway appliance 102 may communicate with a Cloud Server 114 of system 100, as described below. In embodiments, gateway appliance 102 may include a Microcontroller Unit (MCU) 116, Multiple RF Modules 118, a Battery 120 and Supporting Circuitry 122. In embodiments, RF Modules 118 may include any of a number of communication technologies, such as WiFi, cellular and Near Field Communication (NFC) modules, and may be implemented in circuitry, communications circuitry of various types, and/or in combination of software. It is noted MCU 116 may be implemented as a Texas Instruments (TI) CC2630, or the like. Microcontrollers may be embedded controllers that perform compute functions at low power and use relatively quicker sleep-wake and wake-sleep timing. In embodiments, MCU 112 may also contain the Media Access Control (MAC) layer of the wireless radio. It is noted that the Media Access Control Layer is conventionally one of two sublayers that make up the Data Link Layer of the OSI model. The MAC layer is responsible for moving data packets to and from one Network Interface Card (NIC) to another across a shared channel.

In embodiments, gateway appliance 102 may communicate with Cloud Server 114 via Upstream Data Communication Protocol 124, which, in embodiments, as shown, may include a WiFi or cellular connection, or other appropriate communications link, and gateway appliance 102 may communicate with nodes 104-110 over wireless connections 134, using, for example, the IEEE 802.15.4 protocol, or some equivalent protocol, as the case may be. IEEE 802.15.4 is a technical standard which defines the operation of low-rate wireless personal area networks (LR-WPANs). It specifies the physical layer and media access control for LR-WPANs, and is maintained by the IEEE 802.15 working group, which defined the standard in 2003, and published an updated version in 2006, IEEE 802.15.4-2006. Familiarity with these protocols is assumed herein. Additionally, or alternatively, other communication standards or protocols may also be used for communication among components of WSN 100, including Matter, Thread, Open Connectivity Foundation (OCF) specifications, Bluetooth Low Energy (BLE), and/or any other existing or future communication standards or protocols with similar capabilities.

In embodiments, gateway appliance 102 may communicate wirelessly, via RF Modules 118 and communication interface 126 (which may be a modem or other interface over which data may pass) with nodes 104-110 or other such devices in its general physical vicinity. As noted above, the nodes may be smart tags which may be packed inside packages or pallets of merchandise, or attached to them or otherwise associated thereto, as the case may be. Each of the nodes may include a sensor microcontroller unit (MCU), through which it communicates with gateway appliance 102, and a set of sensors, such as one or more of a humidity/temperature sensor which may measure characteristics of the node and/or the node's environment, a multi-axis and tilt sensing accelerometer, location sensor, an ambient light sensor, pressure sensor, a battery, etc. As used herein, and in the claims, nodes assigned to a gateway (e.g., gateway appliance 102) may be said to be part of that gateway's network. In that sense, a wireless sensor network (WSN) includes many such individual gateways (e.g. gateway appliances 102, 112), each with its own “network,” where the gateways may communicate with the cloud, and as described herein, with other gateways, and even with the nodes currently assigned to another gateway. Thus, the WSN may be considered a single network.

Each gateway appliance 102, 112 may receive information from the cloud, e.g., from Cloud Asset Tracking Server 114, regarding which nodes (e.g., smart tags) to hand off to another gateway appliance, such as, for example, informing Current Gateway 102 to hand off custody of some or all of nodes 104-110 to a New Gateway 112. The Cloud Asset Tracking Server may be one or more hardware devices and/or one or more software modules that carry out the collection of data regarding shipments and individual packages or pallets within those shipments, and the tracking of those shipments via data received from various gateways that report to it. In embodiments, the one or more hardware devices may be tamper resistant and the operations may be carried out independent of processor(s) of a host/application platform. In embodiments where the Cloud Asset Tracking Server is implemented as one or more software modules, the software modules may include “enclaves” which (as discussed above) may be isolated regions of code and/or data within the memory of a computing platform.

The Cloud Asset Tracking Server 114 may include a Shipment Management Module 128, a Communication Management Module 130. The Communication Management Module may be one or more software modules that operate in conjunction with one or more hardware devices to configure communications circuitry (not shown) to communicate with one or more gateway appliances 102, 112. The Cloud Asset Tracking Server may include, or may be expanded to include, other module(s) 132. In embodiments, one gateway appliance 102 may communicate with another gateway appliance 112, over wireless protocol 136, which may be a communications protocol based upon 802.15.4, or any other wireless technology.

In some embodiments, the Cloud Asset Tracking Server periodically obtains information from a node, such as to obtain sensor or other data to monitor progress of a node that, for example, may be in transit from an origin to a destination. It will be appreciated a node is expected to be periodically in and out of communication with the Cloud Asset Tracking Server (or other devices) and that a node may store and forward information as needed. It will be further understood that events, such as damage to a node, may occur while in communication with a gateway, in which case a gateway may automatically respond to the even and re-route or otherwise disposition the node. Or, an event such as damage may occur while the node is out of contact, and in such a case a new gateway could identify the event and disposition the node, the Cloud Asset Tracking Server may obtain information from the node identifying the error and the Cloud Asset Tracking Server initiates action to be taken for the node. In one embodiment, the node updates an output to indicate need for resolving an event, such as an exception to sensor limits associated with the node, and a device in the node's environment (e.g., conveyance machines) respond to the event as requested by the node. Such action may be reported to the Cloud Asset Tracking Server, gateways or other devices as needed or desired.

### Autonomous Self-Healing Wireless Sensor Network Topology with Data Logging Using Intelligent Beaconing

### Effective Network Association Using Advertising Beacons

In a wireless sensor network, it is important for clients (e.g., sensor nodes) to be able to join the network quickly. Typically, this requires a client to quickly scan channels to obtain the necessary information, including the primary channel managed by a particular server (e.g., gateway node) and the timeslot for sending a contention request to the server to associate with the network. Given that there are typically multiple channels available, however, scanning the channels to get the requisite information from the server can be time consuming and may impact the battery life of the client. Moreover, when a client attempts to join the network, security features should also be considered, such as requiring the network to be capable of performing device authentication before allowing a client to associate with the network.

Accordingly, this disclosure presents a solution that leverages an advertising or discovery beacon feature to address the problems noted above. In this solution, the server and clients agree on a specific advertising channel (e.g., ahead of time). The server periodically sends an advertising beacon on the advertising channel, and when clients are trying to join the network, they listen on the advertising channel for the ad beacon from the server. This advertising beacon is carefully designed to include the various pieces of information required for clients to associate with or join the network. In this manner, the described solution enables clients to easily and quickly obtain the information required to join the network from the server, thus preserving significant battery life. Further, in some embodiments, the advertising beacon may also include extra security parameters to help authenticate a device and/or provide other security-related features.

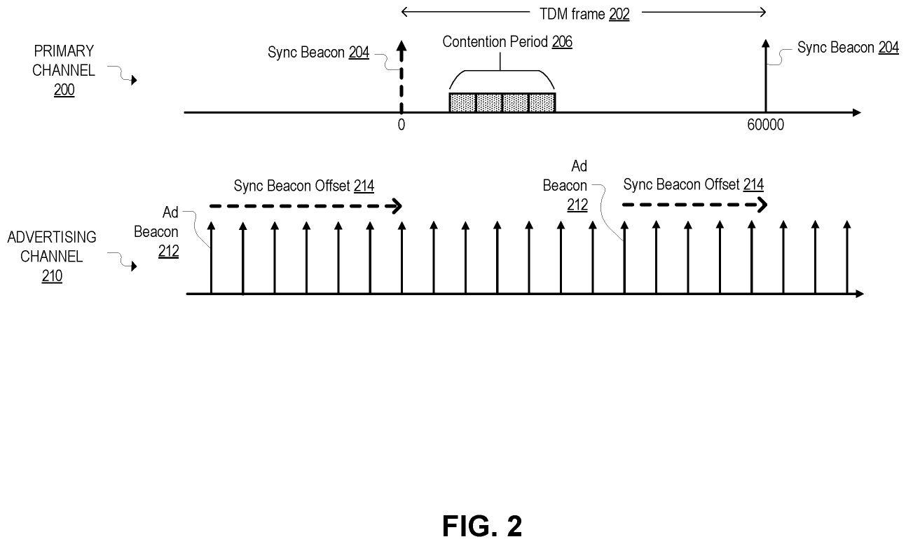

FIG. 2 illustrates signal timing diagrams 200, 210 for a wireless sensor network (WSN) that leverages advertising or discovery beacons to enable clients to associate with the network. In particular, signal timing diagram 200 depicts signals on the primary communication channel managed by the server, and signal timing diagram 210 depicts signals on an advertising channel.

In some embodiments, for example, to eliminate the need for channel scanning on the clients, an advertising channel 210 is agreed on by the server (e.g., gateway node) and clients (e.g., sensor nodes) to deliver the necessary information for network association. For example, the server periodically sends advertising beacons 212 on the advertising channel 210, and the clients listen in on this channel 210 before joining the network. In some embodiments, the time period or interval in which the server sends the advertising beacons 212 is configurable, which enables it to be easily adapted to any power-saving strategy on the server. In some cases, for example, the time period for the advertising beacons 212 is set to much a shorter interval than regular synchronization beacons 204 on the primary channel 200, which helps clients capture the requisite information for joining the network much faster.

Once the clients receive an advertising beacon 212, they are aware of the network settings and can then associate with or join the network (e.g., via the server) based on the information in the advertising beacon 212.

In some embodiments, for example, each advertising beacon 212 includes or identifies the following network parameters: the primary channel 200 managed by the server, an offset 214 to the next regular beacon 204, a slot ID vacancy flag, and/or a security/encryption key for device authentication. Examples of these parameters are shown in Table 1.

TABLE 1
Example Fields of an Advertising Beacon

| FIELD NAME | LENGTH | | DESCRIPTION |
|---|---|---|---|
| PrimaryChannel | 1 | byte | The normal channel on which the server transmits |
| | | | regular beacons. |
| OffsetToNextRegularBeacon | 2 | bytes | The time offset to the next regular synchronization |
| | | | beacon on the primary channel. |
| SlotAvailable | 1 | bytes | Whether there is a slot available for new clients |
| | | | seeking to join the network. |
| ServerECDHPublicKey | 64 | bytes | A security key for device authentication. |

Thus, with respect to the complete procedure, on receiving the advertising beacon 212, the client waits for the offset 214 to the next regular beacon 204 and checks whether there is still a free slot id for a new tag. If an empty slot is available, then the client can switch to the primary channel 200 to capture the next regular beacon 204. At that point, the client is synchronized with the server and can start the contention request (e.g., during the contention period 204) in order to associate with the network. If the slot id vacancy flag is set to false, then the network has reached its maximum capacity, and thus the server prevents any new tags from associating with the network.

With respect to security, the advertising beacon 212 can include information that enables device authentication prior to association with the network, which may depend on the particular the authentication algorithm between the clients and the server. For example, if the server and clients are using an Elliptic-curve Diffie-Hellman (ECDH) algorithm to derive the authentication key, then the server's ECDH public key can be inserted into the advertising beacon 212. In this case, clients can easily derive the authentication key based on its own ECDH private key and the server's ECDH public key. The server and clients can depend on this common authentication key to perform device authentication in the contention request from the clients.

In the illustrated example, the server periodically transmits (i) advertising beacons 212 on the advertising channel 210 and (ii) synchronization beacons 204 on the primary channel 200, with the ad beacons 212 being transmitted much more frequently than the sync beacons 204.

In particular, the primary channel 200 is organized into time-division-multiplexed (TDM) frames 202, each of which begins with a sync beacon 204 from the server, followed by a contention period 206 which is reserved for contention requests from clients seeking to join the network. Since the timing of the contention period 206 is tied to the sync beacon 204, a client must receive a sync beacon 204 prior to sending a contention request, as the client is unaware of when the contention period 206 takes place until a sync beacon 204 is received. However, scanning channels and listening for sync beacons 204 for extended durations can drain the client's battery.

Thus, in the illustrated example, the client first listens for an ad beacon 212 on a predetermined advertising channel 210. Once received, the ad beacon 212 informs the client of the primary channel 200 used by the server and the time offset 214 to the next sync beacon 204 that the server will transmit on the primary channel 200. Since ad beacons 212 are transmitted relatively frequently compared to sync beacons 204, the client can quickly receive an ad beacon 212, determine the primary channel 200 and time offset 214 to the next sync beacon 204, and then sleep until shortly before the next sync beacon 204 is transmitted. In this manner, the client avoids scanning channels and listening for sync beacons 204 for extended lengths of time, thus consuming less power and improving overall battery life.

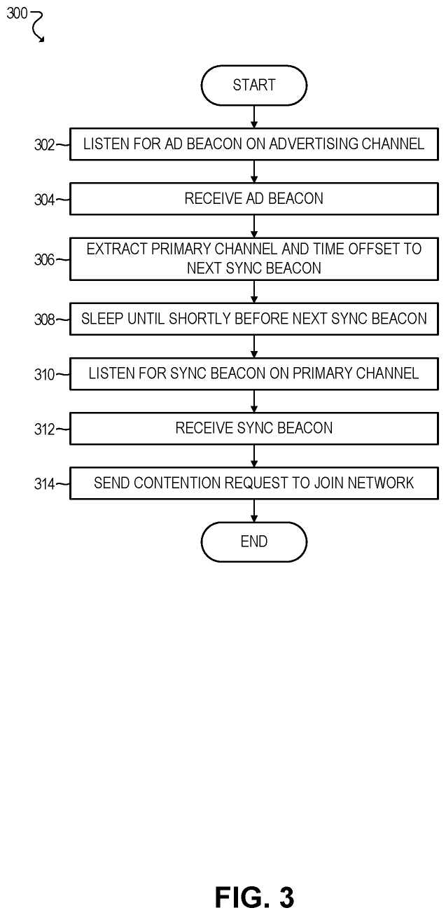

FIG. 3 illustrates a flowchart 300 for associating with a wireless sensor network (WSN) using advertising beacons in accordance with certain embodiments. In some embodiments, for example, flowchart 300 may be performed by a sensor node seeking to join a WSN.

The flowchart begins at block 302, where a sensor node listens on an advertising channel for an ad beacon from a gateway node.

The flowchart then proceeds to block 304, where the sensor node receives an ad beacon on the advertising channel.

The flowchart then proceeds to block 306, where the sensor node extracts the primary channel and the time offset to the next sync beacon from the ad beacon.

The flowchart then proceeds to block 308, where the sensor node sleeps until shortly before the next sync beacon is transmitted on the primary channel (e.g., based on the time offset in the ad beacon).

The flowchart then proceeds to block 310, where the sensor node awakens and listens for the sync beacon on the primary channel at the appropriate time (e.g., based on the time offset in the ad beacon).

The flowchart then proceeds to block 312, where the sensor node receives a sync beacon on the primary channel.

The flowchart then proceeds to block 314, where the sensor node sends a contention request during the contention period to join or associate with the WSN.

At this point, the flowchart may be complete. In some embodiments, however, the flowchart may restart and/or certain blocks may be repeated. For example, in some embodiments, the flowchart may restart at block 302 to associate or re-associate with the same or another network or gateway.

### Smooth Network Join Process in a Wireless Sensor Network Using Contention Slots Via a Smart Beacon

In a wireless sensor network (WSN) implemented using time-division multiplexing (TDM), every client device requires an assigned time slot to communicate with a gateway or server managing the network. These time slots may either be allotted by the gateway during the gateway-to-sensor client pairing process or be requested on the fly by the sensor clients. However, when multiple clients need to join a gateway's WSN ad hoc, it can be time consuming, competitive, and chaotic. In addition, there is a need to allow a sensor client to join a new gateway's WSN quickly without impacting the client's battery life. Further, in some cases, a client may be unable to acquire the time slot information in a timely manner during the association process, and thus a mechanism is needed to enable the client to request and retrieve the slot information again without interfering with other clients' communications.

Accordingly, this disclosure presents a solution that introduces a new smart beacon feature to streamline and smoothen out the WSN join process when multiple clients are attempting to join simultaneously. In this solution, the gateway will reserve a contention period within a normal TDM frame through which any client can contend for and win the slot to send out a request for slot information. Moreover, in some embodiments, the contention slot for every client is kept random to ensure that all sensor clients have the same probability of winning the contention.

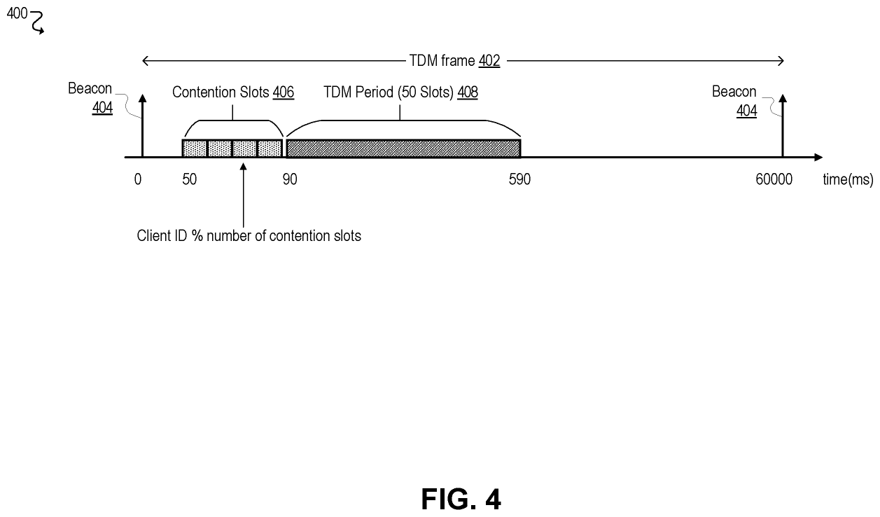

FIG. 4 illustrates a signal timing diagram 400 for a wireless sensor network (WSN) that leverages assigned contention slots 406 for clients seeking to associate with the network. In the illustrated example, when a “smart beacon” 404 feature is enabled on a server (e.g., gateway node), the server reserves a contention period with multiple contention slots 406 after the “smart” synchronization beacon 404 in each TDM frame 402. The total number of contention slots and the slot width may be configurable, thus enabling the network to scale to any number of clients (e.g., sensor nodes). In some embodiments, for example, the contention slot configuration may be specified in the periodic smart beacons 404 transmitted by the server. For example, each smart beacon 404 may indicate the time offset to the start of the contention period, the number of contention slots, and the contention slot width, among other information. Further, clients are randomly assigned to the contention slots for the purpose of sending contention requests to join the network. In this manner, instead of having all clients compete to join the network during the same contention period, each client is assigned to one of several contention slots, thus giving all clients the same opportunity to compete to join the network.

For example, the contention slot position/index for every client may be variable and/or randomized. In some embodiments, for example, the contention slot index may be determined by computing the remainder of the client ID (e.g., a universally unique identifier (UUID)) divided by a configurable contention MOD setting (e.g., corresponding to the number of contention slots), as shown by the following equation:

contention_slot_index=client_ID % CONFIG_CONTENTION_MOD_VALUE.

In this manner, every client is randomly assigned to one of the contention slots, and all clients have the same chance to win the contention and send a request for slot information to the gateway. Once this request is received by the gateway, the gateway sends out allotted slot information (e.g., a slot assignment from the TDM period 408 reserved in every TDM frame 402) to the client at the next beacon 404 without disturbing other clients. In this manner, a client can quickly join a new gateway's WSN, and if the client loses its slot information, the client can quickly retrieve the slot information again.

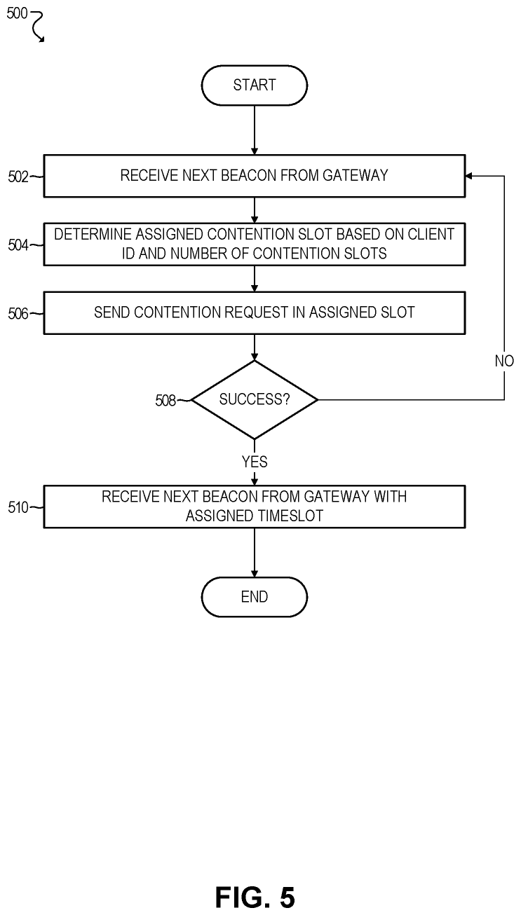

FIG. 5 illustrates a flowchart 500 for associating with a wireless sensor network (WSN) using an assigned contention slot in accordance with certain embodiments. In some embodiments, for example, flowchart 500 may be performed by a sensor node seeking to join a WSN.

The flowchart begins at block 502, where a sensor node listens on the primary channel to receive the next smart synchronization beacon transmitted by a gateway node. In some embodiments, for example, each smart beacon indicates the time offset to the start of the contention period in the current frame, the number of contention slots in the contention period, and the contention slot width, among other information. Alternatively, or additionally, sensor nodes may be informed of the parameters of the contention period through other means (e.g., broadcast via other beacons, predetermined, statically or dynamically configured, etc.).

Upon receiving the beacon, the flowchart proceeds to block 504, where the sensor node determines its assigned contention slot for sending a request to join the network. In some embodiments, for example, the sensor node computes its assigned slot index by taking its unique client ID number modulo (MOD) the number of contention slots, or client_id % num_contention_slots, which refers to the remainder after dividing the client ID by the number of contention slots. In this manner, the result of the computation is somewhere in the range of 0 to num_contention_slots−1, and that value serves as the index to the particular contention slot assigned to the sensor node.

The flowchart then proceeds to block 506, where the sensor node sends a contention request in its assigned contention slot to the gateway node.

The flowchart then proceeds to block 508 to determine if the contention request was successful.

If the contention request was successful, the flowchart proceeds to block 510, where the sensor node listens for and receives the next beacon from the gateway node, which specifies an assigned timeslot in each frame for the sensor node to communicate with the gateway node.

If the contention request was unsuccessful, the flowchart proceeds back to block 502, where the sensor node waits for the next beacon from the gateway and then sends another contention request in its assigned contention slot after receiving the beacon. The flowchart continues in this manner until the contention request is successful.

At this point, the flowchart may be complete. In some embodiments, however, the flowchart may restart and/or certain blocks may be repeated. For example, in some embodiments, the flowchart may restart at block 502 to associate or re-associate with the same or another network or gateway.

### Fast Healing of a Wireless Sensor Network Using Rapid Nano Beacons from the Gateway to Synchronize Stranded/Unsynchronized Clients

In a typical dense RF environment, signal interference can cause momentary connectivity loss in a wireless sensor network (WSN). This is particularly problematic for a beaconing-based WSN, which depends on the periodic synchronization beacons from the gateway to maintain the sensor network. Every time connectivity between the sensor devices and the gateway breaks, the sensor devices must reestablish synchronization with the gateway. This is also problematic for battery-powered sensor devices, as they may spend significant time synchronizing or establishing a connection with the gateway, which can drain their battery dramatically.

Accordingly, this disclosure presents a novel scheme to quickly heal the synchronization between sensor devices and the gateway whenever any connection disruptions occur in a TDM-based WSN. In particular, a new type of synchronization beacon is used-referred to as a nano beacon-which is sent after the TDM period with a relatively high frequency (e.g., every second).

For example, to help “lost” clients (e.g., clients that have lost connectivity) quickly restore synchronization with a parent gateway, the gateway sends additional beacons, referred to as “nano beacons,” at relatively frequent intervals (e.g., every second) after the TDM period in every normal beacon timeframe. These faster and shorter payload nano beacons (e.g., compared to normal synchronization beacons) contain the time offset to the next TDM synchronization beacon from the gateway (or any other indication of when the next synchronization beacon will be transmitted), which can be used by the sensor devices to resynchronize. Because of the repetitions of nano beacons in a single TDM frame, multiple clients can receive and synchronize to the next TDM beacon for the next round of synchronization simultaneously. This allows for faster healing of the WSN because lost clients also wake up more frequently in the anticipation of receiving the nano beacons. With the two above actions on the gateway and sensor device, a WSN can heal quickly within a couple of TDM frames if any clients become “lost.”

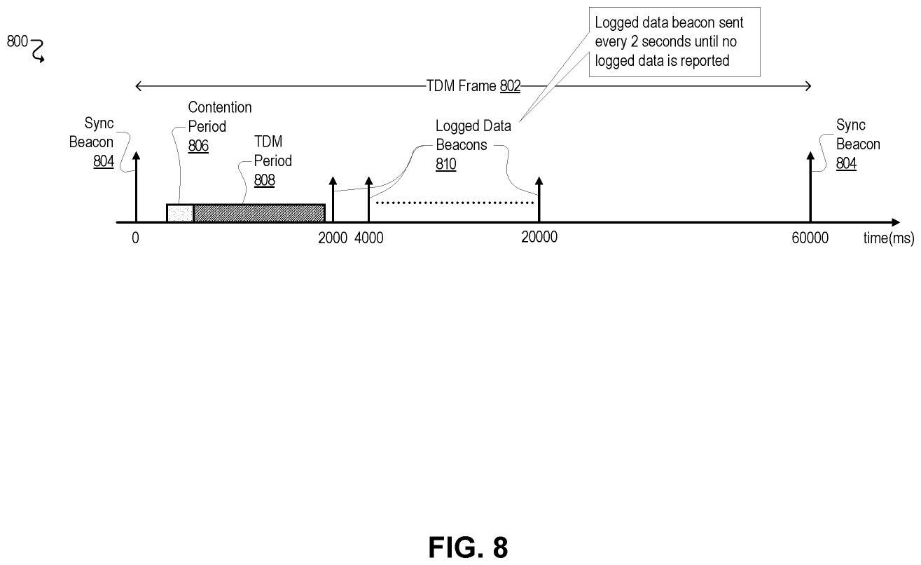

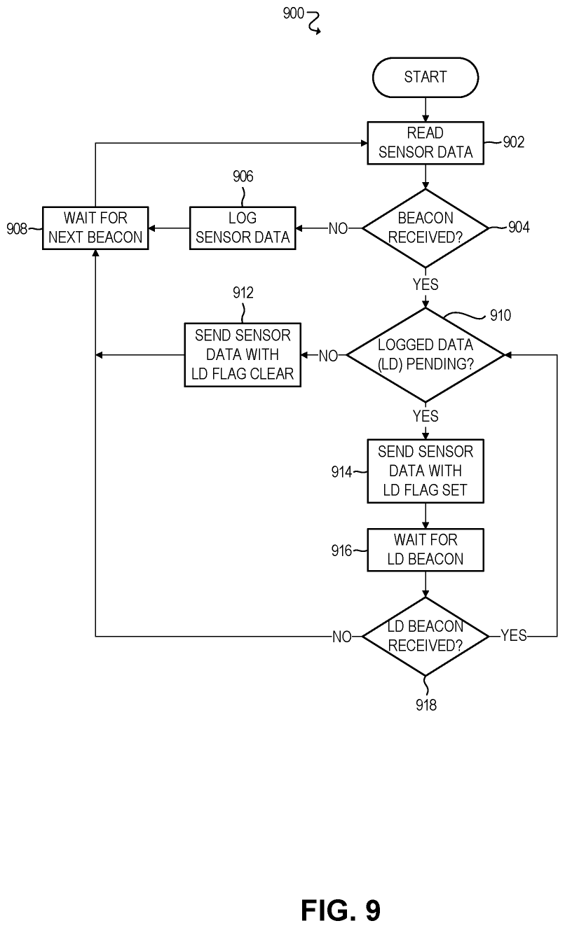

In various embodiments, a nano beacon may also contain other information, such the information contained in an advertising beacon (e.g., as described above in connection with FIGS. 2-3) or a logged data beacon (e.g., as described below in connection with FIGS. 8-9), among other examples.

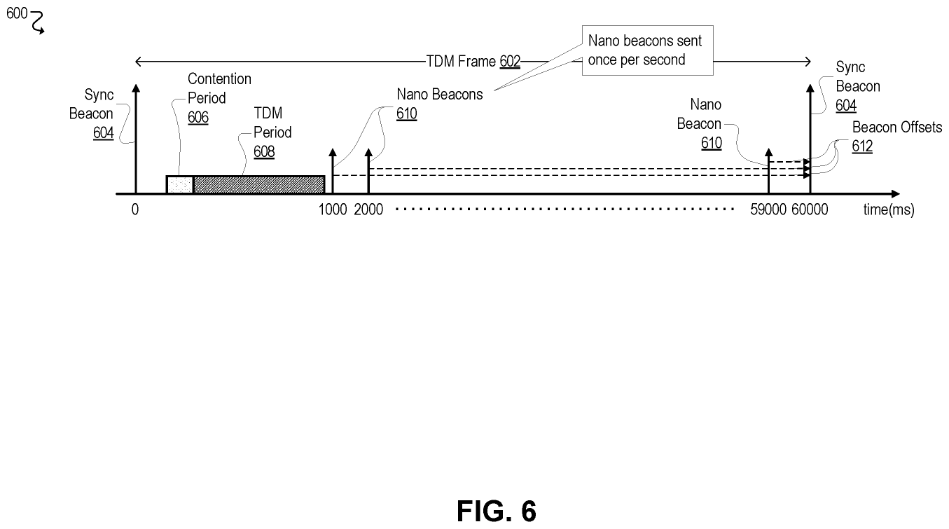

FIG. 6 illustrates a signal timing diagram 600 for a wireless sensor network (WSN) that leverages rapid nano beacons 610 to enable clients (e.g., sensor nodes) to quickly resynchronize with the network after a temporary loss of connectivity. In the illustrated example, the gateway node sends rapid nano beacons 610 at relatively short intervals (e.g., once per second) in the TDM frame 602 following the sync beacon 604, contention period 606, and TDM period 608. Moreover, each nano beacon 610 contains the time offset 612 (or an indication thereof) to the next synchronization beacon 604 from the gateway node, which enables sensor nodes to quickly resynchronize with the gateway node after losing connectivity.

For example, after a temporary loss of connectivity, a sensor node can listen for the next nano beacon 610, extract the time offset 612 from the nano beacon 610 to determine when the next sync beacon 604 is scheduled, and then sleep until shortly before the next sync beacon 604 is transmitted. Since nano beacons 610 are transmitted relatively frequently compared to normal synchronization beacons 604, sensor nodes can quickly receive nano beacons 610 and resynchronize with the gateway node instead of listening for the next synchronization beacon 604 for extended lengths of time.

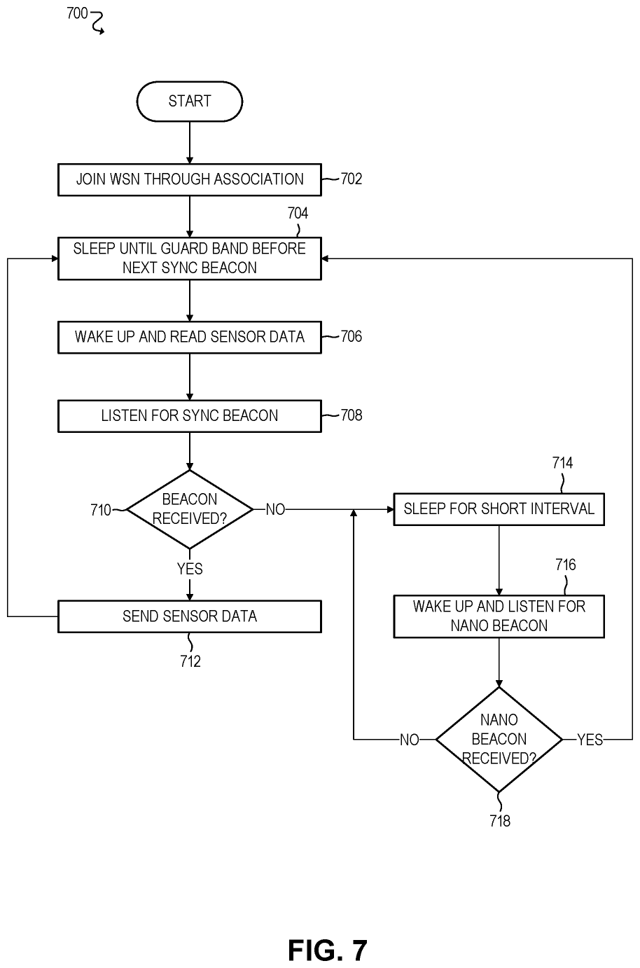

FIG. 7 illustrates a flowchart 700 for quickly resynchronizing with a wireless sensor network (WSN) using nano beacons after losing connectivity. In some embodiments, for example, flowchart 700 may be performed by a sensor node that temporarily loses connectivity to a gateway node of the WSN.

The flowchart begins at block 702, where the sensor node joins the WSN by associating with a gateway node.

The flowchart then proceeds to block 704, where the sensor node sleeps until the guard band before the next synchronization beacon from the gateway node.

The flowchart then proceeds to block 706, where the sensor node wakes up and reads sensor data captured by one or more sensors (e.g., any of the sensors described throughout this disclosure). In some embodiments, for example, a sensor node may periodically read sensor data from its sensors based on a configured sampling frequency.

The flowchart then proceeds to block 708, where the sensor node listens for the next synchronization beacon from the gateway node, and then to block 710 to determine whether the sensor node receives the beacon.

If the sensor node receives the synchronization beacon at block 710, the flowchart proceeds to block 712, where the sensor node sends the sensor data captured during the current sampling period (e.g., at block 706) to the gateway node (e.g., during its allotted timeslot in the TDM period of the frame).

The flowchart then proceeds back to block 704, where the sensor node resumes sleeping until the guard band before the next synchronization beacon. The flowchart continues cycling through blocks 704-712 in this manner until the sensor node eventually loses connectivity and fails to receive a synchronization beacon from the gateway node at block 710.

If the sensor node fails to receive a synchronization beacon at block 710, then the sensor node is presumed to have temporarily lost connectivity with the gateway node (e.g., due to signal interference). As a result, the flowchart proceeds to block 714, where the sensor node sleeps for a short interval, and then to block 716, where the sensor node wakes up and listens for a nano beacon from the gateway node.

The flowchart then proceeds to block 718 to determine whether the sensor node receives a nano beacon from the gateway node. If the sensor node does not receive a nano beacon at block 718, the flowchart cycles back through blocks 714-718 until connectivity is restored and a nano beacon is finally received at block 718.

Once the sensor node receives a nano beacon at block 718, the sensor node extracts the time offset to the next synchronization beacon from the nano beacon, which enables the sensor node to resynchronize with the gateway node. In this manner, after losing connectivity, the sensor node performs frequent wakeups to listen for nano beacons and quickly resynchronize with the gateway node. The flowchart then proceeds back to block 704, where the sensor node resumes sleeping until the guard band before the next synchronization beacon.

The flowchart continues cycling through blocks 704-718 in this manner to continue capturing and reporting sensor data during each sampling period while also maintaining synchronization with the WSN.

### Healing of Data Upon Connectivity Loss in a Synchronized Beacon-Based Wireless Sensor Network Using “Logged Data Beacons”

In certain scenarios, typically due to an interference in the environment, a sensor client in a wireless sensor network (WSN) may lose synchronization with a parent gateway. To recover, the client will wake up more frequently to improve the chances of catching the gateway beacons again even faster. During the absence of communication, there is a need to avoid losing sensor data. Thus, in some embodiments, the sensor data may be cached in the client's non-volatile storage for later upload.

In particular, this disclosure presents a method to save and log sensor data in a sensor client's non-volatile memory/storage whenever the client loses synchronization with the gateway. Once synchronization is restored, this solution provides a mechanism for the sensor client to upload the locally logged data to the gateway. The client will indicate to the gateway in its response that there is some logged sensor data that needs to be uploaded. Then gateway will send a ‘logged data beacon’ periodically (e.g., every two seconds) to quickly collect the logged sensor data. In this manner, data losses or gaps can be prevented in a WSN when the synchronization between the client and gateway is disturbed.

For example, whenever the sensor client loses synchronization with the gateway, it will wake up more frequently to quickly catch the gateway beacons again. In the meantime, to avoid any data gaps on the gateway, the client still reads and saves sensor data in its non-volatile memory at every periodic interval. Once the synchronization is restored, the client will indicate ‘logged data pending’ in its response packet to the gateway by setting a logged data flag in the packet header. With this information subscribed, the gateway will then send a ‘logged data beacon’ every k seconds after the TDM period of every beacon to quickly collect all the logged sensor data from clients. This may continue until no pending logged data is indicated. This approach addresses the data loss/gaps on the gateway application in the absence of connection between gateway and sensor devices.

FIG. 8 illustrates a signal timing diagram 800 for a wireless sensor network (WSN) that leverages logged data beacons to collect sensor data captured during gaps in connectivity. In the illustrated example, following the sync beacon 804, contention period 806, and TDM period 808 in a TDM frame 802, the gateway node sends logged data beacons 810 periodically with a relatively short interval (e.g., every two seconds) to collect unreported sensor data captured during gaps in connectivity. For example, when a sensor node experiences a loss of connectivity, the sensor node logs or caches its sensor data until connectivity is restored, and the sensor node then reports the logged sensor data to the gateway in response to the logged data beacons 810. In some embodiments, the gateway may only transmit the logged data beacons 810 after a sensor node indicates that it has logged sensor data to report (e.g., by setting a flag in the sensor node's response to the gateway). For example, the sensor node may set a flag in its response to the gateway during its normal timeslot 808 in a TDM frame 802, and the gateway may send logged data beacons 810 until the sensor node subsequently indicates that all logged data has been reported (e.g., via a flag in its response). Alternatively, in some embodiments, the gateway may transmit logged data beacons 810 in a TDM frame 802 regardless of whether a sensor node has explicitly indicated that it has logged sensor data to report.

FIG. 9 illustrates a flowchart 900 for logging and reporting sensor data captured during gaps in connectivity with a wireless sensor network (WSN). In some embodiments, for example, flowchart 900 may be performed by a sensor node that loses its connection to a gateway node of the WSN.

The flowchart begins at block 902, where the sensor node reads sensor data captured by one or more sensors (e.g., any of the sensors described throughout this disclosure). In some embodiments, for example, a sensor node may periodically read sensor data from its sensors based on a configured sampling frequency.

The flowchart then proceeds to block 904, where the sensor node listens for the next regular synchronization beacon from the gateway node (e.g., at the start of the next TDM frame).

If the sensor node does not receive a beacon from the gateway node at block 904, then the sensor node is presumed to have lost connectivity with the gateway node (e.g., due to signal interference, the sensor node leaving the vicinity of the gateway node, the gateway node leaving the vicinity of the sensor node, etc.). As a result, the flowchart proceeds to block 906, where the sensor node logs the sensor data obtained at block 902 (e.g., by storing the sensor data in a cache, main memory, or persistent memory/storage of the sensor node) for subsequent transmission once connectivity is restored. The flowchart then proceeds to block 908, where the sensor node waits (e.g., sleeps) until shortly before the next regular beacon is expected from the gateway node.

The flowchart then cycles back through blocks 902-908, where the sensor node continues reading and logging sensor data until the connection is eventually restored and another beacon is received at block 904. For example, the sensor node reads another sample of sensor data, listens for the next beacon from the gateway node, logs the sensor data if no beacon is received, and then waits for the next beacon.

Once the sensor node receives another beacon at block 904, the flowchart proceeds to block 910, where the sensor node determines if it has any logged sensor data to report to the gateway node.

If the sensor node has no logged data at block 910, the flowchart proceeds to block 912, where the sensor node sends the sensor data captured during the current sampling period (e.g., at block 902) to the gateway node with the logged data flag clear. The flowchart then proceeds back to block 908, where the sensor node waits (e.g., sleeps) until shortly before the next regular beacon is expected from the gateway node (e.g., the start of the next TDM frame). The flowchart then restarts at block 902, where the sensor node continues capturing, logging, and/or reporting sensor data during the next sampling period.

If the sensor node has logged data to report at block 910, the flowchart proceeds to block 914, where the sensor node sends the sensor data captured during the current sampling period (e.g., at block 902) to the gateway node with the logged data flag set.

The flowchart then proceeds to block 916, where the sensor node waits for a logged data beacon from the gateway node, and then to block 918, where the sensor node determines if the logged data beacon is received.

If the sensor node receives the logged data beacon at block 918, the flowchart proceeds back to block 910, where the sensor node determines if any logged sensor data is still pending aside from the logged data that will be sent in response to the current logged data beacon.

If the sensor node determines that no other logged sensor data is pending at block 910, the flowchart proceeds to block 912, where the sensor node sends the remaining logged sensor data to the gateway node with the logged data flag clear. The flowchart then proceeds back to block 908, where the sensor node waits for the next regular beacon from the gateway node (e.g., the start of the next TDM frame), and the flowchart then restarts at block 902, where the process repeats for the next sampling period and corresponding TDM frame.

If the sensor node determines that additional logged sensor data is still pending at block 910, the flowchart proceeds to block 914, where the sensor node sends logged sensor data to the gateway node with the logged data flag set. The flowchart then proceeds to block 916, where the sensor node waits for the next logged data beacon from the gateway node. The flowchart continues cycling through blocks 910-918 in this manner until the sensor node determines that no other logged sensor data is pending at block 910.

If the sensor node does not receive a logged data beacon at block 918, then the connection may have been lost or the current TDM frame may have ended. Thus, the flowchart proceeds back to block 908, where the sensor node waits for the next regular beacon from the gateway node (e.g., the start of the next TDM frame), and the flowchart then restarts at block 902, where the process repeats for the next sampling period and corresponding TDM frame.

The flowchart continues cycling through blocks 902-918 in this manner to continue capturing, logging, and/or reporting sensor data to the WSN via a gateway node during each sampling period and corresponding TDM frame.

### Secure Onboarding and Transfer of Tags

### Secure Onboarding of Wireless Sensor Network Tags to Gateway and Logistics Cloud

Sensing devices used in logistics services need to be able to connect to Internet-connected stationary gateway nodes on their shipping route. For example, these sensing devices typically have limited compute, storage, and wireless capabilities, yet they are expected to capture sensor data throughout the entire journey of a shipment, which can last up to 90 days in some cases. Due to size constraints, however, these sensing devices also have limited battery capacity, as a sensing device cannot exceed the size of a visiting box or package. As a result, in view of the shipment duration, a sensing device needs a mechanism to discover and securely connect with infrastructure gateways along the shipping route to push or offload sensor data captured by the sensing device.

Sensor tags owned by different logistics operators generally all operate on the same shared wireless spectrum (e.g., 2.4 GHz). Moreover, in some cases, logistics operators may sell their manufactured sensor tags to other competing logistics operators. Ultimately, however, the sensor data generated by those sensor tags should only be accessible to and interpreted by their true owner. Thus, one of the primary challenges is ensuring that a sensor tag only connects to the infrastructure of its actual owner.

In an operating environment, for example, a sensor tag should only connect to trusted gateways and should only divulge its sensor data after determining that all participants—the sensor tag, the gateway, and the cloud—are trusted or owned by a common authority.

Accordingly, this disclosure presents a solution to verify the authenticity of the respective participants that interact with each other as part of the same sensor network, including the sensor tag, the gateway, and the cloud. For example, the described solution enables a sensor device to discover and verify the authenticity of a gateway before sensor data is shared with the gateway. The gateway then forwards the sensor data to cloud software. If the cloud recognizes the identity of the sensor device and determines that the device belongs to one of its shipments, it proceeds to trigger a challenge to the sensor device. This challenge process ensures that the sensor device and the gateway device both share the same root of trust. If a malicious cloud attempts to lure this sensor tag in, the sensor tag can determine the cloud is unauthentic due to a failed challenge sequence. In the event of failure, the sensor tag attempts to detect other gateway candidates to establish a new connection with other cloud software.

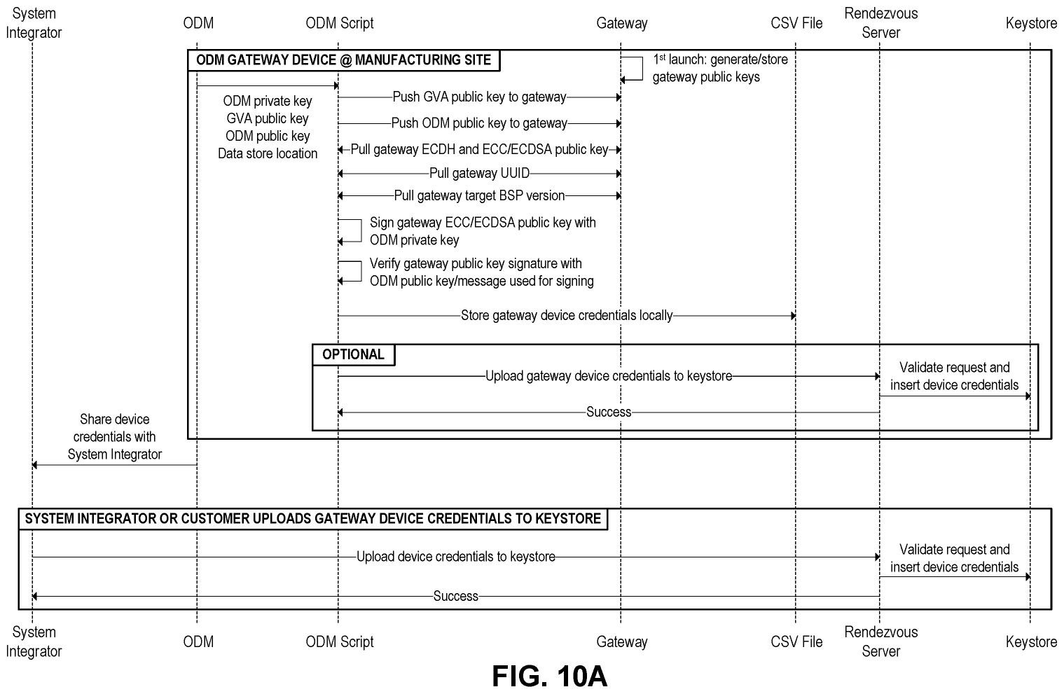

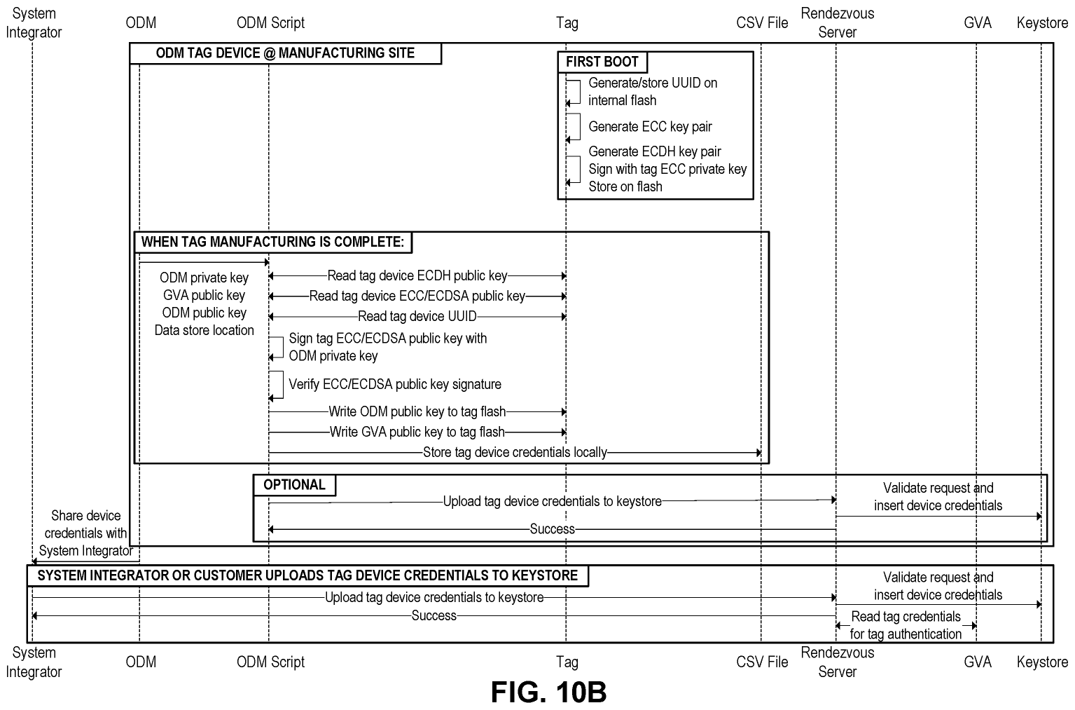

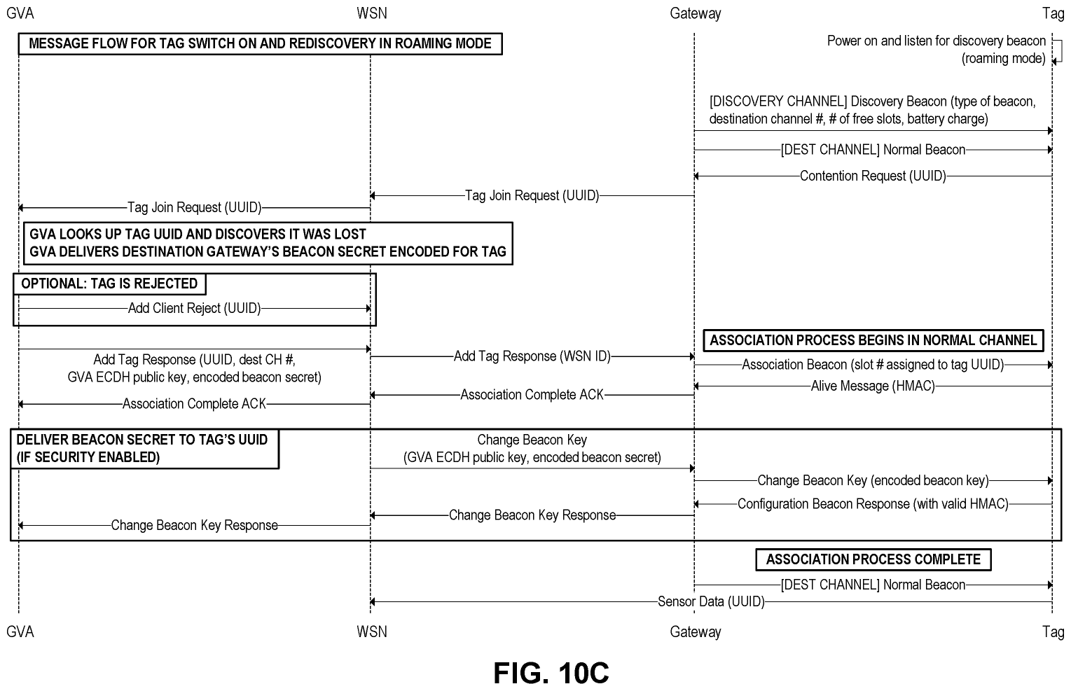

FIGS. 10A-C illustrate example process flows depicting this solution. For example, as described further below, FIG. 10A illustrates an example process for secure onboarding of a gateway, FIG. 10B illustrates an example process for secure onboarding of a sensor tag, and FIG. 10C illustrates an example of a sensor tag join and challenge process.
1. Key Exchange Scheme:
   a. The following steps describe the ECDH key exchange protocol as part of the device's association with the Cloud (gateway virtual appliance (GVA)) (A crypto chip—Atmel ATECC608A provides HW accelerated ECDH capability)
   b. GVA and the device each generate ECDH public and private keys using their respective crypto infrastructure. (This is the Diffie Hellman scheme)
   c. GVA exchanges this information with every device it interacts.
   d. The device sends its ECDH public key to GVA over the air.
   e. The GVA and respective devices compute the shared secret—ShSe. Therefore, for every GVA-device combination, a unique ShSe is now derived.
   f. The curve used is: prime256v1 (as seen in nodejs crypto libraries). This is the same as NIST P-256 as noted in http://csrc.nist.gov/groups/ST/toolkit/documents/dss/NISTReCur.pdf.
   g. These are the keys created as part of the manufacturing process:
      i. Tag ECDH Key(s)
         These keys are generated within Sensor Tag during manufacturing. The public key (PK) portion will be signed by the Tag's Device Key and is extracted as part of the production cycle. This is shared with the System Integrator by the ODM. At rest storage of private portion will be within ATEC508A secure key slot.
         The dimensions of the keys are: 256 bits.
      ii. GW ECDH Key(s)
         These keys are generated within GW during manufacturing. The public key (PK) portion shared with the System Integrator by the ODM. At rest storage of private portion will be within SOFIA's secure area.
         The dimensions the keys are: 256 bits.
      iii. GVA ECDH Key(s)
         This key is an ECDE key generated by GVA. The public key (PK) portion will be delivered to the devices as part of over the air signaling. At rest storage of the private portion will be stored within a secure KeyStore of GVA in the cloud. While the device's ECDH keys do not change during the lifetime of the device, the GVA's keys can be refreshed.
      iv. Shared secret generation (ShSe)
         As described above, the exchange of public portions between the device and the cloud is used to derive a common secret based on the Diffie Helman key exchange protocol between the device and the GVA.
2. Session keys (derived) and how they are used
   a. Authentication Key (Ak): HMAC-SHA256 (keysize=32)
      i. This is an ephemeral shared key calculated from the ECDH key exchange protocol between the devices and GVA to be used in a HMAC operation for subsequent payload authentication.
      ii. This is computed from GVA ECDH Private Key & GW ECDH Public Key. (Note—that the GW uses the GW ECDH Private Key and GVA ECDH Public Key to derive the same Ak value)
      iii. This key is securely stored in local storage in the Tag and GW. The GVA is also expected to securely manage this.
      iv. Reference source code is shared Ak derivation as part of GVA sources
      v. Cryptographically it is defined as follows:
         KeyMaterial2=HMAC-SHA-256[0, (byte)2∥“CastleCanyonKDF” ∥(byte)0∥“WSN-GWAssociation-hmac”∥ShSe]
         kWSN_SessionAuthenticationKey=KeyMaterial2[0 . . . 32] (256 bits, to feed SHA256)
   b. Encryption Key (Ek): AES128
      i. This is the ephemeral shared key calculated from the key exchange protocol between the devices and GVA to be used in a AES128 operation for payload encryption.
      ii. This is computed from GVA ECDH Private Key & GW ECDH Public Key. (Note—that the GW uses the GW ECDH Private Key and GVA ECDH Public Key to derive the same Ek value)
      iii. This key is securely stored in local storage in the Tag and GW. The GVA is also expected to securely manage this.
      iv. Cryptographically it is defined as follows:
         KeyMaterial1=HMAC-SHA-256[0, (byte)1∥“CastleCanyonKDF”∥(byte)0∥“WSN-GWAssociation-cipher”∥ShSe]
      v. kWSN_SessionEncryptionKey=KeyMaterial1[0 . . . 15] (128 bits, to feed AES128)
   c. BeaconAuthenticationKey (Beacon Secret): HMAC-SHA256 (keysize=32) Note: Applicable only for WSN Security
      i. This is the shared key to be used in a HMAC operation for subsequent payload authentication between a Tag and GW in for WSN Messages.
      ii. The concept of a shared key is employed because the WSN node (WSN server) in the gateway has limited memory. Therefore, it was not possible for it to be aware of every tag's Ek/Ak in order to be able to authenticate messages received from each tag. In order to simplify this task, the BeaconAuthenticationKey (sometimes called “Beacon Secret”) was defined.
      iii. The beacon secret is associated with each GW's WSN. This secret is derived in the GVA and sent to the GW device.
      iv. Cryptographically, the secret is defined as follows:
         GVArefreshinput=a nonce generated by the GVA
         KeyMaterial1=HMAC-SHA-256[KBeacon0, (byte)1∥“CastleCanyonKDF”∥(byte)0∥“WSN-BeaconRefresh-hmac”∥GVArefreshinput]
         KWSN_Common_BeaconAuthenticationKey KeyMaterial1[0 . . . 32] (256 bits, to feed SHA256)
      v. The beacon secret is delivered to each tag over the air by encoding with the tag's Ek.
3. Device Challenge mechanism
   a. For the devices to be authenticated, the GVA issues a challenge and awaits a response. This response is on a pre-defined function that the GVA uses to determine if the device challenged is in possession of the same derived Ak key.
   b. The GW is challenged by the GVA when it is powered on. This interaction requires the GW to share their UUID and receive the GVA's ECDH Public key along with a Nonce. The GW then responds with the challenge response.
   c. The Tag is handed a challenge by the GVA when the GW forwards the add_tag_request from the tag to the GVA. The challenge is sent through the add_tag_response message from the GVA. The challenge response is issued by the Tag after it has joined the WSN. Note: Applicable only for WSN Security
   d. As shown below, the GVA issues a Nonce and verifies the Challenge response based on the Device's Authentication Key.

ChallengeResponse=HMAC-SHA-256 (kWSN_SessionAuthenticationKey,Nonce∥deviceUUID)

### Secure Transfer of Custody

In a typical asset tracking solution, assets are tracked using low-power devices with wireless capabilities, which change custody at different way points. For example, when these low-power wireless sensor devices are deployed for real-time asset tracking and condition monitoring, they are repeatedly handed off between sensor networks from one gateway to another throughout their shipment journey. These gateways typically include a combination of mobile and stationary gateways, such as: (i) battery-powered gateways that accompany the sensor devices for some or all of the journey; and/or (ii) infrastructure or warehouse gateways deployed on the distribution floor. Moreover, the sensor devices change custody from one gateway to another as the associated assets are being transported. Every time a sensor device changes custody, however, it needs to securely reestablish synchronization and authentication with the new gateway's managed sensor network. This can be problematic for battery-powered sensor devices, as they often spend a significant amount of time synchronizing and establishing connections with each new gateway, which can drain their battery life dramatically.

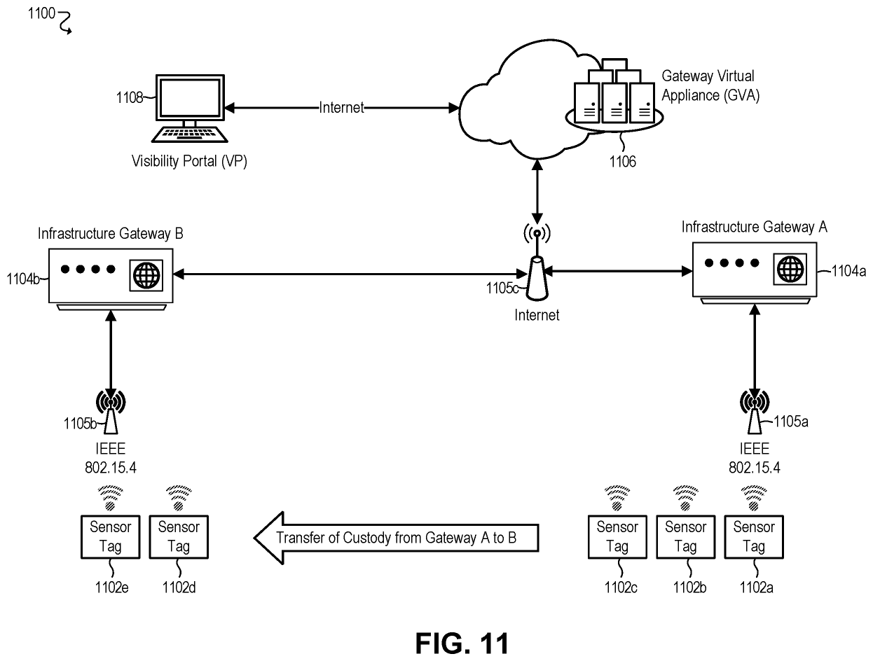

Accordingly, this disclosure presents a solution that enables quick and secure transfer of custody of sensor clients between gateways. In particular, the described solution introduces a method to safely migrate one or more tags in a shipment from one gateway to another, as depicted by the example shown in FIG. 11.

FIG. 11 illustrates an example of a secure transfer of custody of sensor tags 1102a-e in a wireless sensor network (WSN) 1100. In the illustrated example, WSN 1100 includes sensor tags 1102a-e, gateways 1104a-b, access points 1105a-c, gateway virtual appliance (GVA) 1106, and visibility portal 1108. The sensor tags 1102a-e and gateways 1104a-b communicate with each other via access points 1105a-b (e.g., IEEE 802.15.4 access points), and the gateways 1104a-b communicate with each other and/or over the Internet (e.g., with GVA 1106 and/or visibility portal 1108) via access point 1105c (e.g., an IEEE 802.11 access point).

In the illustrated example, sensor tags 1102a-c are initially connected to gateway 1104a, while sensor tags 1102d-e are connected to gateway 1104b. At some point, sensor tags 1102a-c are subsequently transferred from gateway 1104a to gateway 1104b (e.g., when the sensor tags and/or their associated assets are transported from one location to another). This transfer of custody between gateways 1104a-b is performed in a secure manner to ensure that the sensor devices 1102a-e and the gateways 1104a-b are all authorized to participate in the WSN 1100, as described further below.

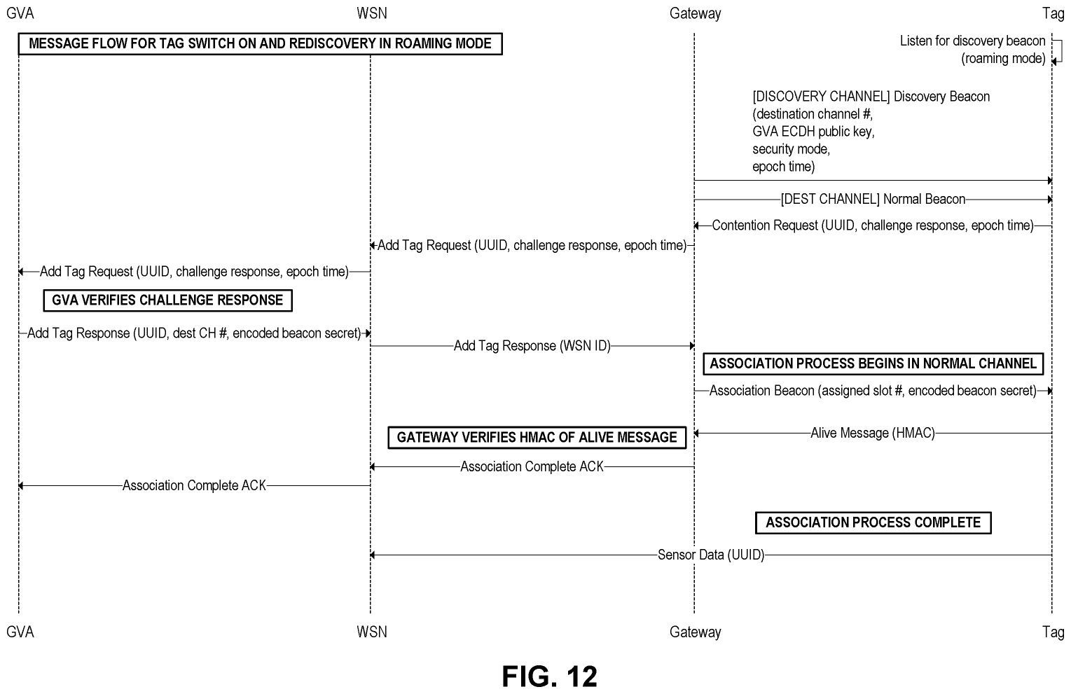

FIG. 12 illustrates an example sequence flow for performing a secure transfer of custody for a sensor tag. For example, in the middle of a custody change, a mutual authentication challenge process is conducted between the tags and the new gateway to ensure they can all be properly authenticated. In addition, a new beacon key encrypted by an encryption key (EK) is sent to the tags to replace the existing beacon key, which can subsequently be used for verification of incoming beacons from the new gateway.

For custody transfer to happen securely, a common root of trust is established at the time of manufacturing. Each device (e.g., gateways and sensor devices) creates a pair of keys and using the Diffie Helman key-exchange protocol, they derive a common secret between the device and the virtual gateway (cloud). The private artifacts in the infrastructure gateway and the sensing device are stored inside a cryptographic chip, which is used to compute message responses as part of the mutual authentication process.

Whenever a sensor device powers on, it joins a sensor network managed by a gateway. When the sensor device loses connection with the gateway, it starts a process of re-discovery of a gateway. If the re-discovered gateway is different from the previous one, a custody transfer process is performed to transfer custody of the sensor device to the new gateway. Since the gateway devices are connected to the same cloud, the sensor device's association with the original shipment is preserved. If the sensor device generates sensor data while roaming (e.g., while the sensor device is not connected to a gateway), the sensor data will subsequently be forwarded once the sensor device is re-discovered by a new gateway.

The join process begins when the sensor device makes a request to “Join” the wireless sensor network created by the gateway using a wirelessly-transmitted “Contention Request.” In response, the gateway formulates an “Add Tag Request” JSON command containing a tag identifier (e.g., a universally unique identifier (UUID)) and a “challenge response” from the sensor tag, which the gateway sends to the cloud. The cloud then authenticates the sensor tag based on the tag's challenge response contained in the “Add Tag Request” command. Once the sensor tag is authenticated by the cloud, the cloud sends an “Add Tag Response” JSON message back to the gateway, and the tag then goes through the association process to join the wireless sensor network of the new gateway. On the other hand, if the challenge response contained in the “Add Tag Request” message fails the authentication check, an “Add Tag Response” message is not delivered to the gateway, and the sensor tag will eventually time out and consider this to be a failed attempt.

When a sensor tag stops hearing from the gateway (e.g., the tag can no longer see beacon messages from the gateway), the tag transitions to the “roaming state” and then looks to start the “Join” process again with a new gateway using a “Contention Request” message, as described above.

In this manner, the entire process of transferring custody of a sensor tag to a new gateway-including the tag's authentication process—is optimally executed, which reduces power consumption and extends the battery life of the tag.

### Autonomous “Airplane Mode” for Asset Trackers Using Automated Flight Status Detection

Airlines certification is essential for any sensors supporting logistics business use cases. Many airlines require all RF transmissions to be turned off during takeoff and landing and may optionally allow them to be turned on while cruising and/or upon landing. This requires a mechanism to detect takeoff and landing in a system in order to provide automated RF on/off control per airline regulations.

Accordingly, this disclosure presents a solution to automatically detect takeoff and landing. In particular, the solution uses an algorithm that leverages a fusion of accelerometer sensor profiles and pressure sensor profiles to classify landing, takeoff, and cruising/idle states.

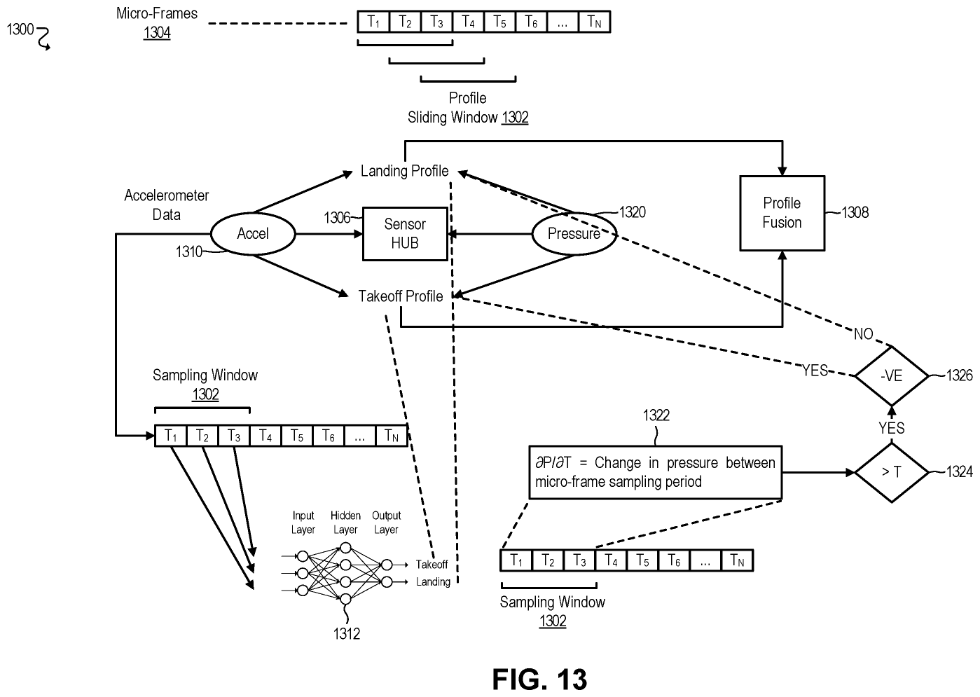

FIG. 13 illustrates an example implementation 1300 of automated takeoff/landing detection using acceleration and pressure data. In particular, the illustrated example employs sensor fusion on an acceleration profile (e.g., using a neural network) and a pressure profile (e.g., based on the change in pressure within a sampling period) to detect takeoff, landing, and/or other flight states (e.g., idle, cruise).

In the illustrated embodiment, a combination of neural network and statistical methods are used to gain the consensus between accelerometer 1310 and pressure sensor 1320 profiles for takeoff and landing. The accelerometer 1310 samples the average acceleration for each of N sampling slots or “micro-frames” 1304 in a rolling window, which may be referred to as a sampling period or sampling window 1302. In the illustrated example, the sampling period 1302 includes three slots 1304. The average acceleration of each sampling slot 1304 in the current sampling period 1302 is fed into the pre-trained neural network 1312 as N inputs (e.g., three inputs in FIG. 13). The output of the neural network 1312 classifies the inputs as takeoff, landing, cruising, or idle states. The pressure sensor 1320 calculates the rise or drop in pressure 1322 for N consecutive sampling slots 1304 in the current window 1302. If there is a continuous rise or continuous drop in pressure for each sampling slot 1304 that exceeds a certain threshold 1324, then the profile is marked as landing or takeoff depending on whether pressure is rising or dropping 1326. For example, positive pressure differentials (+ve) indicate a continuous rise in pressure, which corresponds to a landing profile since pressure increases as altitude decreases, while negative pressure differentials (−ve) indicate a continuous drop in pressure, which corresponds to a takeoff profile since pressure decreases as altitude increases. A constant pressure indicates a cruising or halt state.

In some embodiments, the takeoff state may be activated if either the acceleration profile or the pressure profile indicates a takeoff is occurring, while the landing state may only be activated if both the acceleration profile and the pressure profile indicate that a landing is occurring. Other embodiments may detect takeoff and landing based on other combinations of the respective acceleration and pressure profiles or using other sensor fusion techniques. In some embodiments, for example, both the acceleration and pressure samples may be fed into a neural network trained to classify the flight state based on acceleration and pressure.

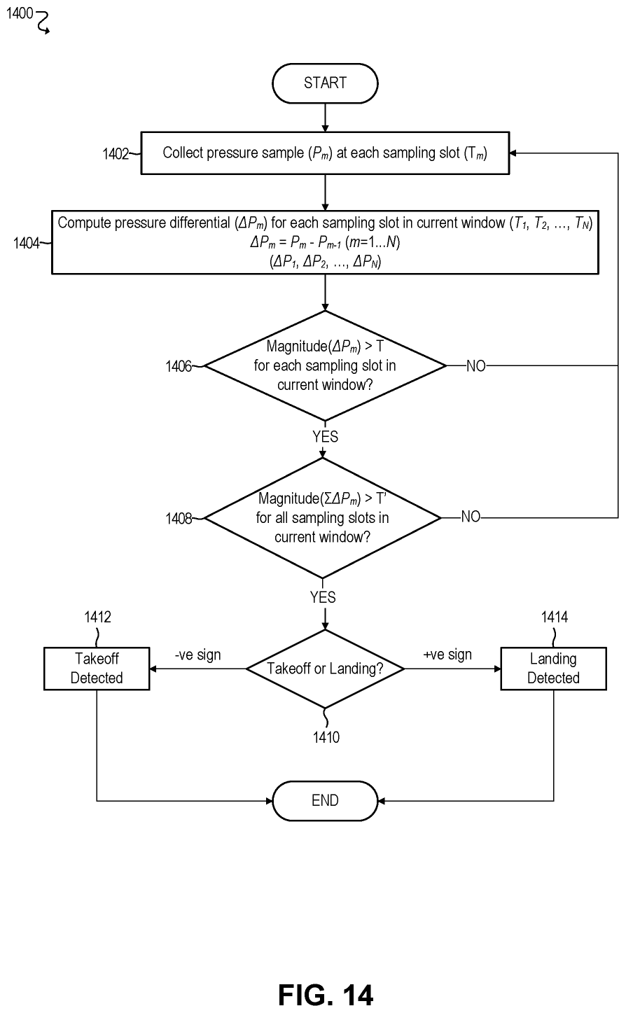

In the illustrated embodiment, the solution is implemented as follows:
(i) A sensor hub 1306 generates a timer pulse and executes an Interrupt Service Routine (ISR) that marks the start of a timing slot;
(ii) The ISR reads the current accelerometer data 1310 and current pressure sensor data 1320 using a pre-configured sampling frequency (in Hz);
(iii) The ISR calculates the average acceleration within the sampling period and adds it to the list of previous average accelerations in previous sampling slots (A₁, A₂, . . . , Aₙ);
(iv) The ISR calculates the pressure difference between the current sampling slot and the previous sampling slot (ΔP₁, ΔP₂, . . . , ΔPₙ);
(v) The state machine feeds the acceleration data (A₁, A₂, . . . , Aₙ) into the pre-trained neural network and reads the classified output, which indicates the flight state (e.g., takeoff, landing, cruising, idle) for the acceleration profile;
(vi) The state machine feeds the pressure differentials (ΔP₁, ΔP₂, . . . , ΔPₙ) into a decision tree (e.g., as shown in FIG. 14), which outputs the flight state for the pressure profile;
(vii) The acceleration and pressure profiles, and/or the underlying data (e.g., A₁, A₂, . . . , Aₙ and ΔP₁, ΔP₂, . . . , ΔPₙ), is then fed into a profile fusion function 1308 that executes a state machine to detect the operational state of the airplane;
(viii) The state is marked as ‘takeoff’ if either the accelerometer or pressure sensor detects a takeoff condition; and
(ix) The state is marked ‘landing’ if both the accelerometer and pressure sensor detect a landing condition.

FIG. 14 illustrates a process flow 1400 for takeoff/landing detection using pressure sensor profiling. In particular, pressure samples (Pₘ) are collected at each sampling slot (e.g., P₁, P₂, . . . , Pₙ) (block 1402), and a state machine calculates the pressure differential (ΔPₘ) between each sampling slot (e.g., ΔP₁, ΔP₂, . . . , ΔPₙ) (block 1404). Each pressure differential (Pₘ) in the current sampling period (e.g., a rolling window of N consecutive samples), along with the sum of all pressure differentials in that sampling period, are then tested against different thresholds to determine if the airplane is taking off or landing.

For example, if the magnitude of all pressure differentials within a single sampling period is greater than a threshold T (block 1406), and the summed pressure differential of all sampling slots within the sampling period is greater than a threshold T′ (block 1408), then the airplane is either taking off or landing (block 1410) depending on the sign of the pressure differentials (blocks 1412, 1414). In particular, if the pressure differentials are negative (e.g., −ve magnitude), then pressure is decreasing, which is indicative of a takeoff condition (block 1412) since pressure decreases as altitude increases. If the pressure differentials are positive (e.g., +ve magnitude), then pressure is increasing, which is indicative of a landing condition (block 1414) since pressure increases as altitude decreases.

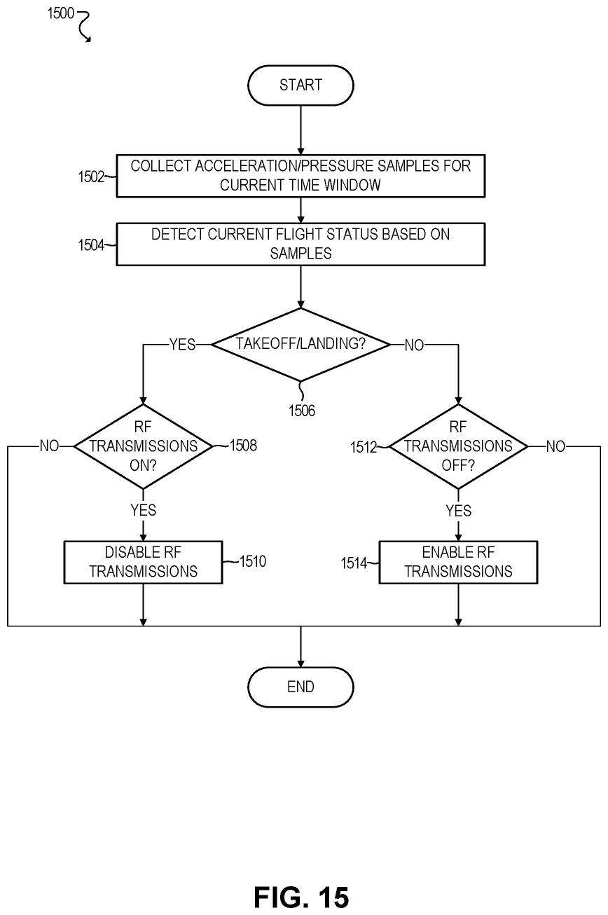

FIG. 15 illustrates a flowchart 1500 for autonomously enabling/disabling radio frequency (RF) transmissions on a device onboard an airplane. In some embodiments, for example, flowchart 1500 may be performed by a sensor node (e.g., an asset tracker) used to track an asset onboard an airplane. In the illustrated embodiment, flowchart 1500 disables RF transmissions during takeoff and landing but enables RF transmission during idle and cruise. In other embodiments, however, different actions may be taken based on the current flight status. For example, in some embodiments, RF transmissions may be disabled at takeoff and subsequently enabled after landing, such that RF transmissions are disabled for the duration of the flight.

The flowchart begins at block 1502 by collecting/computing acceleration and/or pressure samples during the current time window (e.g., using acceleration and/or pressure sensors).

The flowchart then proceeds to block 1504 to detect the current flight status based on the collected samples (e.g., using the techniques described above in connection with FIGS. 13-14). For example, the current flight status may be detected as takeoff, landing, cruise, idle, etc.

The flowchart then proceeds to block 1506 to determine if the current flight status is either takeoff or landing. If the current flight status is either takeoff or landing, the flowchart proceeds to block 1508 to determine if RF transmissions are currently enabled on the device. If RF transmissions are currently enabled, the flowchart proceeds to block 1510 to disable RF transmissions until takeoff or landing is complete. If RF transmissions are already disabled, no further action is required at that time and the flowchart may be complete.

If the current flight status at block 1506 is neither takeoff nor landing, then the current flight status may be idle or cruise. As a result, the flowchart proceeds to block 1512 to determine if RF transmissions are currently disabled on the device. If RF transmissions are currently disabled, the flowchart proceeds to block 1514 to enable RF transmissions during the idle or cruise states. If RF transmissions are already enabled, no further action is required at that time and the flowchart may be complete.

At this point, the flowchart may be complete. In some embodiments, however, the flowchart may restart and/or certain blocks may be repeated. For example, in some embodiments, the flowchart may restart at block 1502 to continue collecting acceleration/pressure samples, detecting the current flight status based on the samples, and enabling/disabling RF transmissions based on the current flight status.

### Automated Asset Tracking and Auditing

The current supply chain process requires physical signatures to legally accept a contract of carriage, register chain of custody, and update the shipment status (e.g., from active to received). There is a substantial need to improve this process based on market research, as 30% of all shipments ($2.5 trillion) are in distress and only 6% of companies report full supply chain visibility.

Accordingly, this disclosure presents a solution to automate and improve receiving outcomes through tracking a shipment's chain of custody and any exceptions/anomalies to shipment thresholds (e.g., violations of shipping terms/requirements for an asset) that could erode its value using real time sensors, blockchain technology, artificial intelligence, and vision systems. For example, this solution automatically tracks and audits location and other sensor data during shipment of an asset (e.g., for farm-to-fork tracking and data logging) and establishes a blockchain-based digital signature of the shipment audit trail. This effectively creates a means to eliminate manual signatures and use authenticated devices to optimize holistic operations.

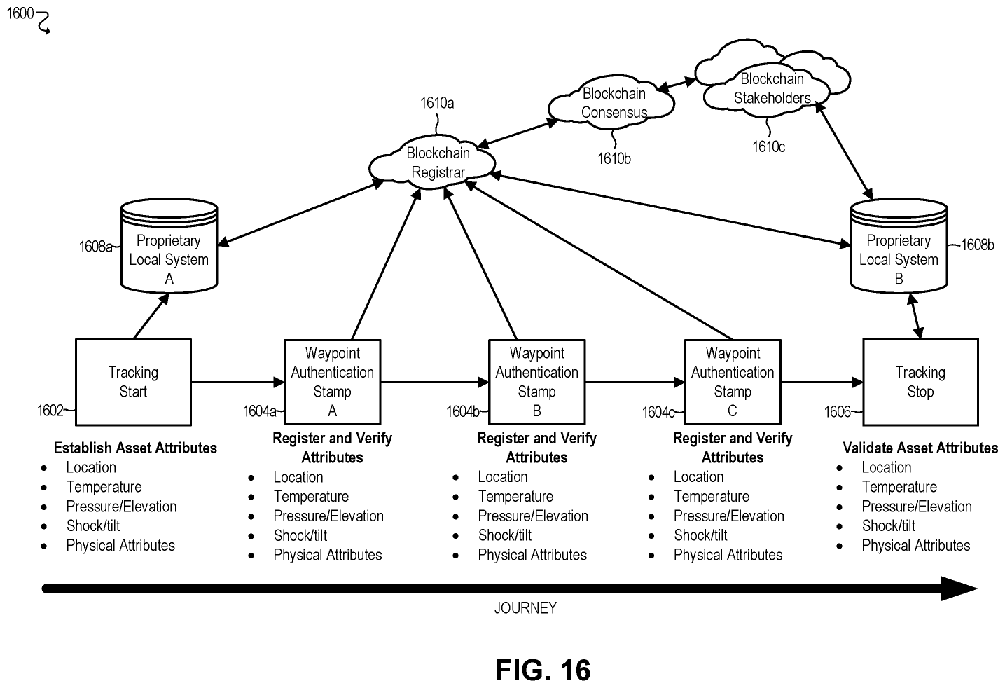

FIG. 16 illustrates an example embodiment 1600 of automated blockchain-based asset tracking and auditing. In particular, a smart tracker authenticated to a shipment is designed to post its shipment tracking data to a blockchain (e.g., via blockchain registrar 1610a, blockchain consensus protocols 1610b, and/or blockchain stakeholders 1610c) rather than exclusively to non-standard, proprietary databases 1608a-b. This may similarly be applied in logistics use cases where establishing provenance (traceability) is critical, such as with minerals, energy, and organic food designation. In a blockchain, links to data objects can be chained and/or kept off chain, such as digital signatures. Once a set of rules/conditions is met (e.g., the authenticated device reaches the destination geofence), the link to the digital signature is “enabled” based on an “if this/then that” configuration, and the signature may then be accessible to the shipper without requiring a physical signatory present.

This solution integrates the above blockchain technology with asset tracker sensors and a vision system to monitor the visual “health” of a shipment, where baseline metrics are established at shipment origin 1602 based on visual markers and sensor data (e.g., location, temperature, pressure/elevation/altitude, shock/tilt, physical characteristics) and are subsequently confirmed at shipment destination/receipt 1606. Additional checks and balances can be incorporated based on the shipment data stream at various waypoints 1604a-c to confirm there were no exceptions to sensor thresholds (e.g., tilt, shock, temp, humidity) for the shipment throughout its journey. In some embodiments, artificial intelligence (AI) and/or machine learning (ML) can also be leveraged to train AI/ML models to a baseline on shipment types instantiated by the industry vertical (e.g., capital, high value, cold chain).

This solution may also be beneficial when there is limited or no visibility into the quality of an asset. Many warehouses are one within a partially connected or disconnected enterprise system, so having the ability to not only autonomously log data relative to asset quality (e.g., never breached temperature, humidity, tilt, or shock thresholds) and receive shipments autonomously within a distributed warehouse system creates a log of emulation.

A vision system or sensor suite at the warehouse edge allows for inferencing and system decision-making in real time and much closer to the tracking devices themselves. This facilitates quicker data processing and reduces dependability on the cloud for faster shipment insights. This also allows the data at play to stay at the edge and the data supporting proof to be lofted to the blockchain for the immutable record, thereby reducing the data bloat on the cloud. This also transcends silos in proprietary systems (e.g., 3PLs/freight forwarders/final mile delivery services).

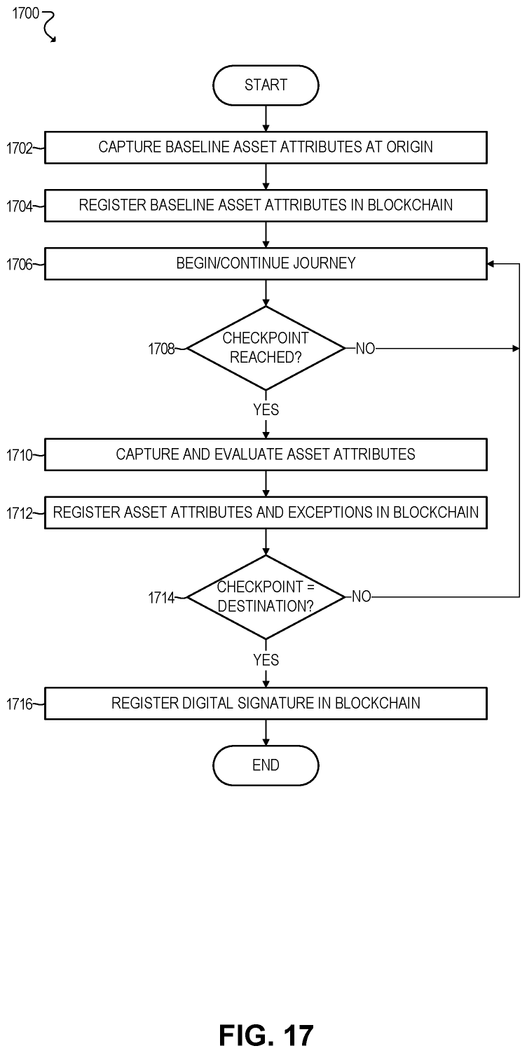

FIG. 17 illustrates a flowchart 1700 for automated asset tracking and shipment auditing. In some embodiments, for example, flowchart 1700 may be performed by one or more sensor nodes used to automatically track and audit an asset during shipment (e.g., using an asset tracker with one or more sensors, cameras deployed throughout the shipment journey, etc.).

The flowchart begins at block 1702 by capturing baseline attributes of an asset at the origin of its journey. For example, location, temperature, humidity, pressure/elevation, shock/tilt, and/or physical attributes of the asset may be captured using a collection of sensors (e.g., location/GPS sensor, temperature/humidity sensors, pressure/elevation sensors, shock/tilt sensors, accelerometer, camera, etc.). In some embodiments, at least some of the sensors may be incorporated into one or more sensor nodes or asset trackers attached to the asset. Additionally, or alternatively, some of the sensors may be deployed in the proximity of the asset and/or throughout the asset's journey. For example, cameras and other vision sensors used to track the object based on its physical attributes and/or appearance may be deployed in or near warehouses, shipping vehicles (e.g., trucks, boats, planes), shipping containers, checkpoints/waypoints, and so forth.

The flowchart then proceeds to block 1704 to register the baseline asset attributes in an asset tracking blockchain.

The flowchart then proceeds to block 1706, where the asset's journey begins, and then to block 1708 to determine when the next checkpoint is reached. For example, a checkpoint may refer to any point throughout the journey-whether defined geographically (e.g., an intermediate waypoint or final destination) or temporally (e.g., minute or hourly checkpoints)—where the current asset attributes are to be captured and evaluated.

In some embodiments, for example, the asset tracker may sleep throughout the journey while periodically waking up to determine if a checkpoint has been reached (e.g., using a location/GPS sensor). If a checkpoint has not been reached at block 1708, the asset tracker resumes sleeping, and the flowchart proceeds back to block 1706 to continue the journey until the asset tracker wakes up once again to determine if a checkpoint has been reached. The flowchart continues cycling through blocks 1706 and 1708 until determining that the next checkpoint has been reached at block 1708.

After reaching the next checkpoint at block 1708, the flowchart proceeds to block 1710 to capture and evaluate the current attributes of the asset at the checkpoint. For example, the current attributes-which may be captured by the asset tracker and/or other sensor nodes—may be the same or similar types of attributes as the baseline attributes that were previously captured at block 1702. Moreover, the current attributes may be evaluated against the baseline attributes and/or other thresholds to determine if any exceptions or violations of the shipping terms occur (e.g., overly high/low temperatures, shock, physical damage, etc.).

The flowchart then proceeds to block 1712 to register the current asset attributes and any exceptions in the blockchain.

The flowchart then proceeds to block 1714 to determine if the current checkpoint is the final destination. If the current checkpoint is not the final destination, the flowchart proceeds back to block 1706 to continue the journey. The flowchart continues cycling through blocks 1706-1714 in this manner until the final destination is reached at block 1714.

Upon determining that the final destination has been reached at block 1714, the flowchart proceeds to block 1716 register a digital signature in the blockchain to indicate that the shipment/journey is complete. In some embodiments, various rules or criteria (e.g., delivery requirements specified by the shipping agreement for the asset) must be evaluated and satisfied before the digital signature can be registered in the blockchain (e.g., the final GPS location of the asset must be within a specified distance of the delivery destination).

At this point, the flowchart may be complete. In some embodiments, however, the flowchart may restart and/or certain blocks may be repeated. For example, in some embodiments, the flowchart may restart at block 1702 to continue tracking the same or another asset on a new journey.

### Example Computing Embodiments

The following section presents examples of various computing devices, systems, architectures, and environments that may be used to implement the wireless sensor network technologies and functionality described throughout this disclosure. In particular, any of the devices and systems described in the following sections may be used to implement sensor nodes, gateway nodes, and/or any other components or functionality of the wireless sensor networks described herein.

### Edge Computing

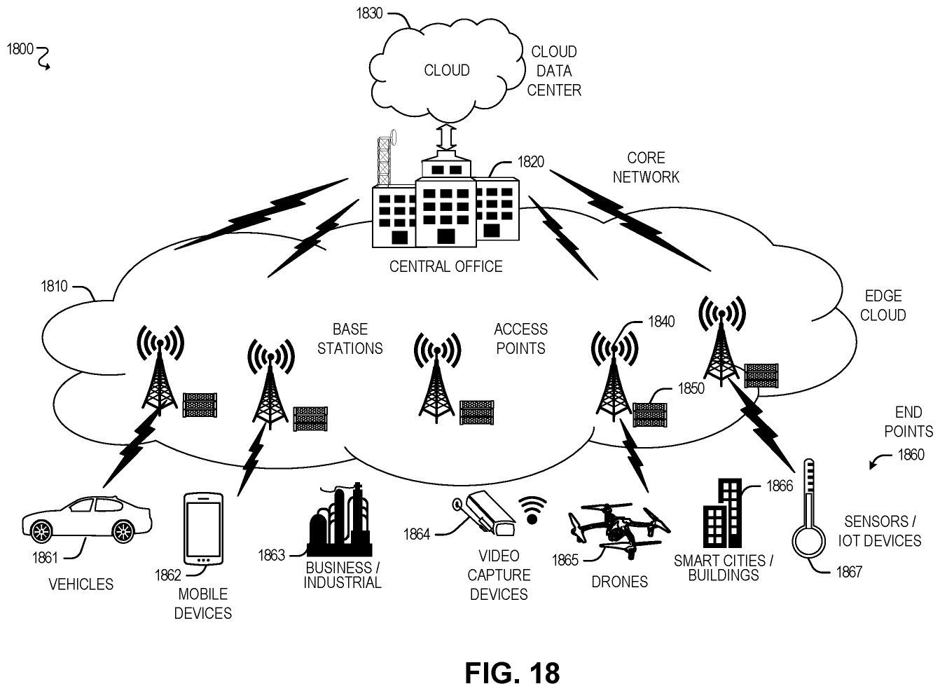

FIG. 18 is a block diagram 1800 showing an overview of a configuration for edge computing, which includes a layer of processing referred to in many of the following examples as an “edge cloud”. As shown, the edge cloud 1810 is co-located at an edge location, such as an access point or base station 1840, a local processing hub 1850, or a central office 1820, and thus may include multiple entities, devices, and equipment instances. The edge cloud 1810 is located much closer to the endpoint (consumer and producer) data sources 1860 (e.g., autonomous vehicles 1861, user equipment 1862, business and industrial equipment 1863, video capture devices 1864, drones 1865, smart cities and building devices 1866, sensors and IoT devices 1867, etc.) than the cloud data center 1830. Compute, memory, and storage resources which are offered at the edges in the edge cloud 1810 are critical to providing ultra-low latency response times for services and functions used by the endpoint data sources 1860 as well as reduce network backhaul traffic from the edge cloud 1810 toward cloud data center 1830 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

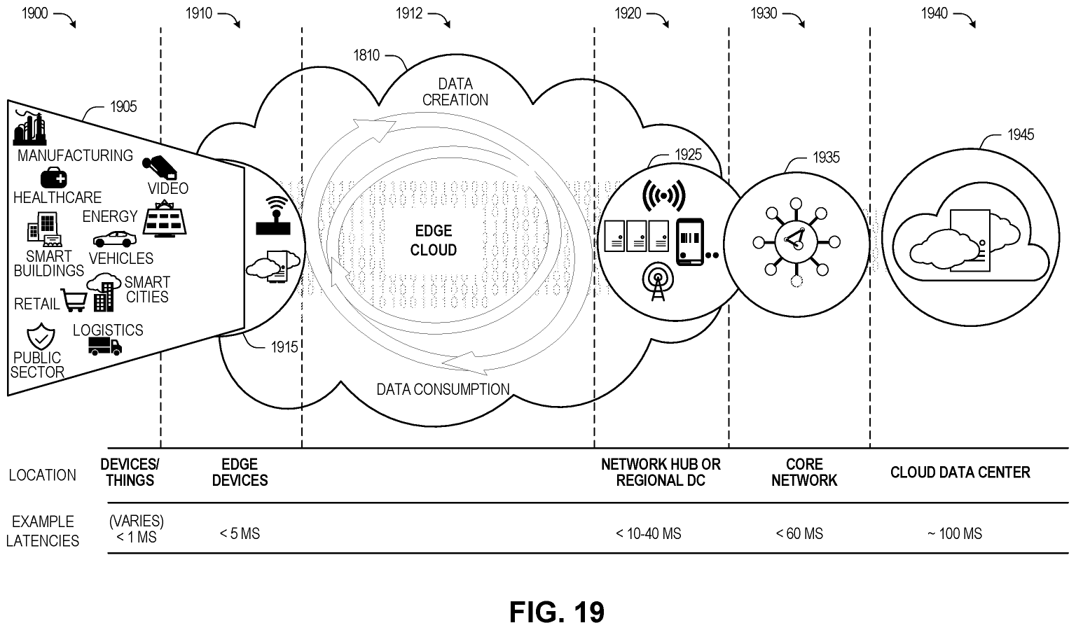

FIG. 19 illustrates operational layers among endpoints, an edge cloud, and cloud computing environments. Specifically, FIG. 19 depicts examples of computational use cases 1905, utilizing the edge cloud 1810 among multiple illustrative layers of network computing. The layers begin at an endpoint (devices and things) layer 1900, which accesses the edge cloud 1810 to conduct data creation, analysis, and data consumption activities. The edge cloud 1810 may span multiple network layers, such as an edge devices layer 1910 having gateways, on-premise servers, or network equipment (nodes 1915) located in physically proximate edge systems; a network access layer 1920, encompassing base stations, radio processing units, network hubs, regional data centers (DC), or local network equipment (equipment 1925); and any equipment, devices, or nodes located therebetween (in layer 1912, not illustrated in detail). The network communications within the edge cloud 1810 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 1900, under 5 ms at the edge devices layer 1910, to even between 10 to 40 ms when communicating with nodes at the network access layer 1920. Beyond the edge cloud 1810 are core network 1930 and cloud data center 1940 layers, each with increasing latency (e.g., between 50-60 ms at the core network layer 1930, to 100 or more ms at the cloud data center layer). As a result, operations at a core network data center 1935 or a cloud data center 1945, with latencies of at least 50 to 100 ms or more, will not be able to accomplish many time-critical functions of the use cases 1905. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 1935 or a cloud data center 1945, a central office or content data network may be considered as being located within a “near edge” layer (“near” to the cloud, having high latency values when communicating with the devices and endpoints of the use cases 1905), whereas an access point, base station, on-premise server, or network gateway may be considered as located within a “far edge” layer (“far” from the cloud, having low latency values when communicating with the devices and endpoints of the use cases 1905). It will be understood that other categorizations of a particular network layer as constituting a “close”, “local”, “near”, “middle”, or “far” edge may be based on latency, distance, number of network hops, or other measurable characteristics, as measured from a source in any of the network layers 1900-1940.

The various use cases 1905 may access resources under usage pressure from incoming streams, due to multiple services utilizing the edge cloud. To achieve results with low latency, the services executed within the edge cloud 1810 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 1810 may provide the ability to serve and respond to multiple applications of the use cases 1905 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 1810 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 1810 (network layers 1900-1940), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 1810.

As such, the edge cloud 1810 is formed from network components and functional features operated by and within edge gateway nodes, edge aggregation nodes, or other edge compute nodes among network layers 1910-1930. The edge cloud 1810 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 1810 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

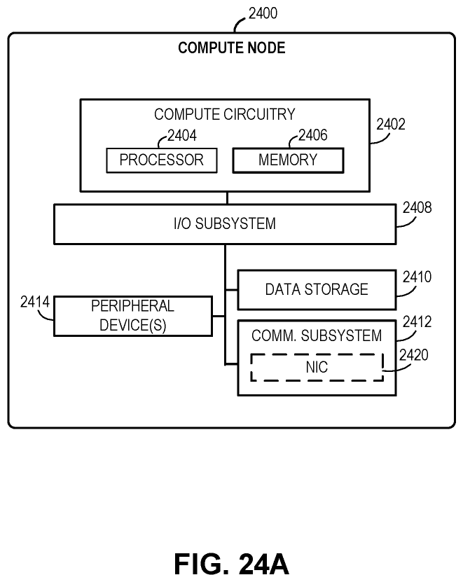

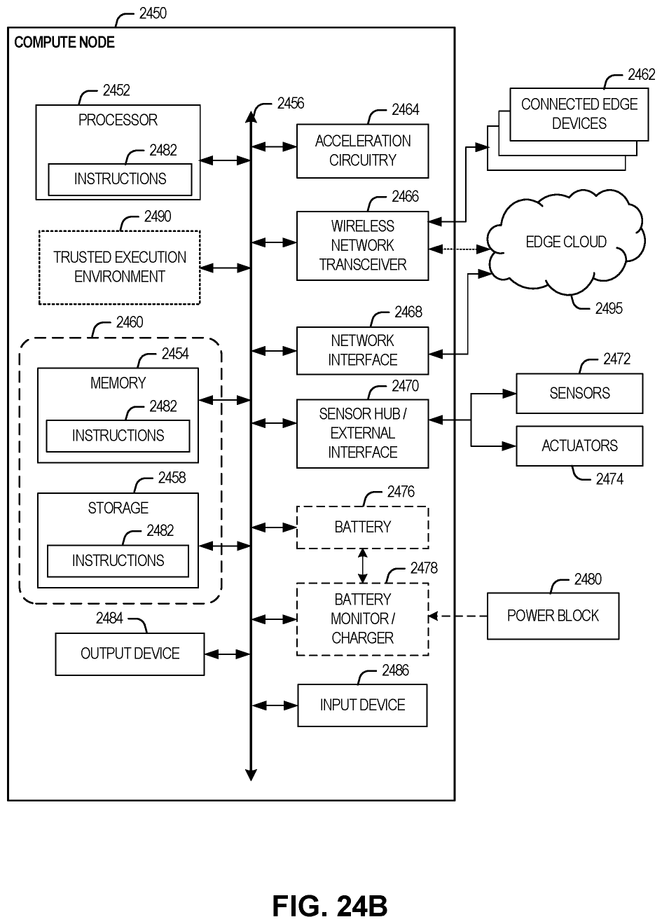

The network components of the edge cloud 1810 may be servers, multi-tenant servers, appliance computing devices, and/or any other type of computing devices. For example, the edge cloud 1810 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIGS. 24A-B. The edge cloud 1810 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

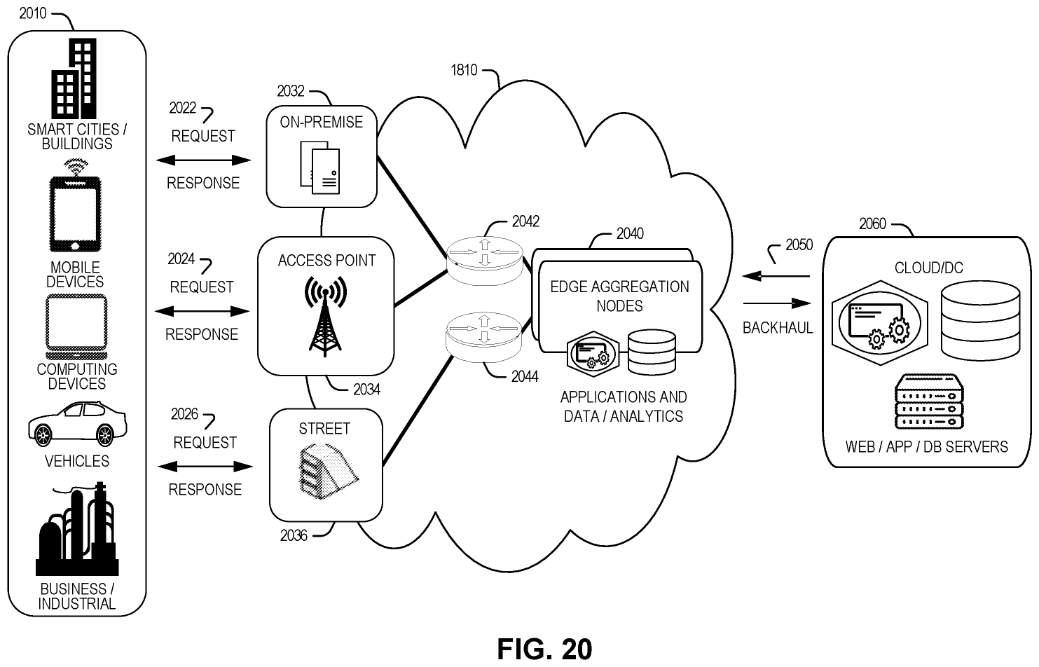

In FIG. 20, various client endpoints 2010 (in the form of mobile devices, computers, autonomous vehicles, business computing equipment, industrial processing equipment) exchange requests and responses that are specific to the type of endpoint network aggregation. For instance, client endpoints 2010 may obtain network access via a wired broadband network, by exchanging requests and responses 2022 through an on-premise network system 2032. Some client endpoints 2010, such as mobile computing devices, may obtain network access via a wireless broadband network, by exchanging requests and responses 2024 through an access point (e.g., cellular network tower) 2034. Some client endpoints 2010, such as autonomous vehicles may obtain network access for requests and responses 2026 via a wireless vehicular network through a street-located network system 2036. However, regardless of the type of network access, the TSP may deploy aggregation points 2042, 2044 within the edge cloud 1810 to aggregate traffic and requests. Thus, within the edge cloud 1810, the TSP may deploy various compute and storage resources, such as at edge aggregation nodes 2040, to provide requested content. The edge aggregation nodes 2040 and other systems of the edge cloud 1810 are connected to a cloud or data center 2060, which uses a backhaul network 2050 to fulfill higher-latency requests from a cloud/data center for websites, applications, database servers, etc. Additional or consolidated instances of the edge aggregation nodes 2040 and the aggregation points 2042, 2044, including those deployed on a single server framework, may also be present within the edge cloud 1810 or other areas of the TSP infrastructure.

### Internet-of-Things (IoT)

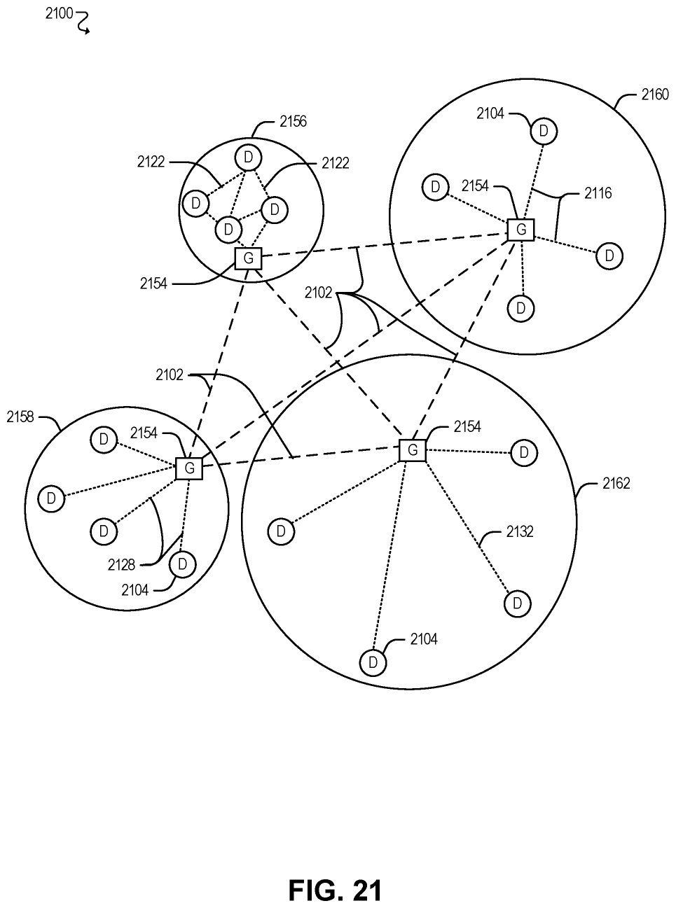

FIG. 21 illustrates an example domain topology for respective internet-of-things (IoT) networks coupled through links to respective gateways. The internet of things (IoT) is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar cost to smaller numbers of larger devices. However, an IoT device may be a smart phone, laptop, tablet, or PC, or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

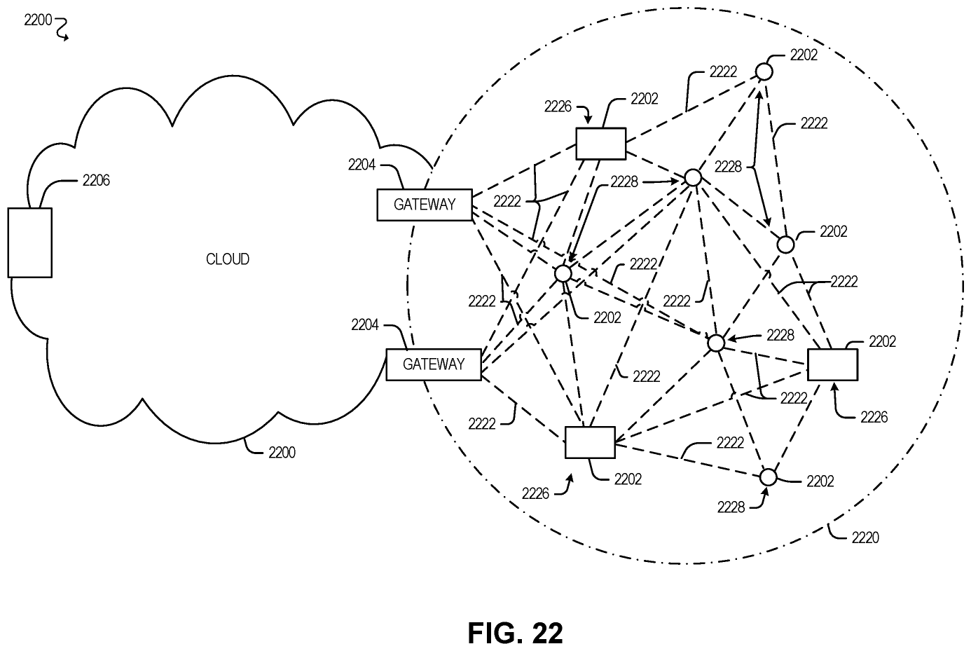

The future growth of the Internet and like networks may involve very large numbers of IoT devices. Accordingly, in the context of the techniques discussed herein, a number of innovations for such future networking will address the need for all these layers to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time or space. The innovations include service delivery and associated infrastructure, such as hardware and software; security enhancements; and the provision of services based on Quality of Service (QoS) terms specified in service level and service delivery agreements. As will be understood, the use of IoT devices and networks, such as those introduced in FIGS. 21 and 22, present a number of new challenges in a heterogeneous network of connectivity comprising a combination of wired and wireless technologies.

FIG. 21 specifically provides a simplified drawing of a domain topology that may be used for a number of internet-of-things (IoT) networks comprising IoT devices 2104, with the IoT networks 2156, 2158, 2160, 2162, coupled through backbone links 2102 to respective gateways 2154. For example, a number of IoT devices 2104 may communicate with a gateway 2154, and with each other through the gateway 2154. To simplify the drawing, not every IoT device 2104, or communications link (e.g., link 2116, 2122, 2128, or 2132) is labeled. The backbone links 2102 may include any number of wired or wireless technologies, including optical networks, and may be part of a local area network (LAN), a wide area network (WAN), or the Internet. Additionally, such communication links facilitate optical signal paths among both IoT devices 2104 and gateways 2154, including the use of MUXing/deMUXing components that facilitate interconnection of the various devices.

The network topology may include any number of types of IoT networks, such as a mesh network provided with the network 2156 using Bluetooth low energy (BLE) links 2122. Other types of IoT networks that may be present include a wireless local area network (WLAN) network 2158 used to communicate with IoT devices 2104 through IEEE 802.11 (Wi-Fi®) links 2128, a cellular network 2160 used to communicate with IoT devices 2104 through an LTE/LTE-A (4G) or 5G cellular network, and a low-power wide area (LPWA) network 2162, for example, a LPWA network compatible with the LoRaWan specification promulgated by the LoRa alliance, or a IPv6 over Low Power Wide-Area Networks (LPWAN) network compatible with a specification promulgated by the Internet Engineering Task Force (IETF). Further, the respective IoT networks may communicate with an outside network provider (e.g., a tier 2 or tier 3 provider) using any number of communications links, such as an LTE cellular link, an LPWA link, or a link based on the IEEE 802.15.4 standard, such as Zigbee®. The respective IoT networks may also operate with use of a variety of network and internet application protocols such as Constrained Application Protocol (CoAP). The respective IoT networks may also be integrated with coordinator devices that provide a chain of links that forms cluster tree of linked devices and networks.

Each of these IoT networks may provide opportunities for new technical features, such as those as described herein. The improved technologies and networks may enable the exponential growth of devices and networks, including the use of IoT networks into “fog” devices or integrated into “edge” computing systems. As the use of such improved technologies grows, the IoT networks may be developed for self-management, functional evolution, and collaboration, without needing direct human intervention. The improved technologies may even enable IoT networks to function without centralized controlled systems. Accordingly, the improved technologies described herein may be used to automate and enhance network management and operation functions far beyond current implementations.

In an example, communications between IoT devices 2104, such as over the backbone links 2102, may be protected by a decentralized system for authentication, authorization, and accounting (AAA). In a decentralized AAA system, distributed payment, credit, audit, authorization, and authentication systems may be implemented across interconnected heterogeneous network infrastructure. This allows systems and networks to move towards autonomous operations. In these types of autonomous operations, machines may even contract for human resources and negotiate partnerships with other machine networks. This may allow the achievement of mutual objectives and balanced service delivery against outlined, planned service level agreements as well as achieve solutions that provide metering, measurements, traceability, and trackability. The creation of new supply chain structures and methods may enable a multitude of services to be created, mined for value, and collapsed without any human involvement.

Such IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration and quality of service (QoS) based swarming and fusion of resources. Some of the individual examples of network-based resource processing include the following.

The mesh network 2156, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

The WLAN network 2158, for instance, may use systems that perform standards conversion to provide multi-standard connectivity, enabling IoT devices 2104 using different protocols to communicate. Further systems may provide seamless interconnectivity across a multi-standard infrastructure comprising visible Internet resources and hidden Internet resources.

Communications in the cellular network 2160, for instance, may be enhanced by systems that offload data, extend communications to more remote devices, or both. The LPWA network 2162 may include systems that perform non-Internet protocol (IP) to IP interconnections, addressing, and routing. Further, each of the IoT devices 2104 may include the appropriate transceiver for wide area communications with that device. Further, each IoT device 2104 may include other transceivers for communications using additional protocols and frequencies. This is discussed further with respect to the communication environment and hardware of an IoT processing device depicted in FIGS. 24A-B and 23.

Finally, clusters of IoT devices may be equipped to communicate with other IoT devices as well as with a cloud network. This may allow the IoT devices to form an ad-hoc network between the devices, allowing them to function as a single device, which may be termed a fog device, fog platform, or fog network. This configuration is discussed further with respect to FIG. 22 below.

FIG. 22 illustrates a cloud computing network in communication with a mesh network of IoT devices (devices 2202) operating as a fog platform in a networked scenario. The mesh network of IoT devices may be termed a fog network 2220, established from a network of devices operating at the edge of the cloud 2200. To simplify the diagram, not every IoT device 2202 is labeled.

The fog network 2220 may be considered to be a massively interconnected network wherein a number of IoT devices 2202 are in communications with each other, for example, by radio links 2222. The fog network 2220 may establish a horizontal, physical, or virtual resource platform that can be considered to reside between IoT edge devices and cloud or data centers. A fog network, in some examples, may support vertically-isolated, latency-sensitive applications through layered, federated, or distributed computing, storage, and network connectivity operations. However, a fog network may also be used to distribute resources and services at and among the edge and the cloud. Thus, references in the present document to the “edge”, “fog”, and “cloud” are not necessarily discrete or exclusive of one another.

As an example, the fog network 2220 may be facilitated using an interconnect specification released by the Open Connectivity Foundation™ (OCF). This standard allows devices to discover each other and establish communications for interconnects. Other interconnection protocols may also be used, including, for example, the optimized link state routing (OLSR) Protocol, the better approach to mobile ad-hoc networking (B.A.T.M.A.N.) routing protocol, or the OMA Lightweight M2M (LWM2M) protocol, among others.

Three types of IoT devices 2202 are shown in this example, gateways 2204, data aggregators 2226, and sensors 2228, although any combinations of IoT devices 2202 and functionality may be used. The gateways 2204 may be edge devices that provide communications between the cloud 2200 and the fog network 2220, and may also provide the backend process function for data obtained from sensors 2228, such as motion data, flow data, temperature data, and the like. The data aggregators 2226 may collect data from any number of the sensors 2228, and perform the back end processing function for the analysis. The results, raw data, or both may be passed along to the cloud 2200 through the gateways 2204. The sensors 2228 may be full IoT devices 2202, for example, capable of both collecting data and processing the data. In some cases, the sensors 2228 may be more limited in functionality, for example, collecting the data and allowing the data aggregators 2226 or gateways 2204 to process the data.

Communications from any IoT device 2202 may be passed along a convenient path between any of the IoT devices 2202 to reach the gateways 2204. In these networks, the number of interconnections provide substantial redundancy, allowing communications to be maintained, even with the loss of a number of IoT devices 2202. Further, the use of a mesh network may allow IoT devices 2202 that are very low power or located at a distance from infrastructure to be used, as the range to connect to another IoT device 2202 may be much less than the range to connect to the gateways 2204.

The fog network 2220 provided from these IoT devices 2202 may be presented to devices in the cloud 2200, such as a server 2206, as a single device located at the edge of the cloud 2200, e.g., a fog network operating as a device or platform. In this example, the alerts coming from the fog platform may be sent without being identified as coming from a specific IoT device 2202 within the fog network 2220. In this fashion, the fog network 2220 may be considered a distributed platform that provides computing and storage resources to perform processing or data-intensive tasks such as data analytics, data aggregation, and machine-learning, among others.

In some examples, the IoT devices 2202 may be configured using an imperative programming style, e.g., with each IoT device 2202 having a specific function and communication partners. However, the IoT devices 2202 forming the fog platform may be configured in a declarative programming style, enabling the IoT devices 2202 to reconfigure their operations and communications, such as to determine needed resources in response to conditions, queries, and device failures. As an example, a query from a user located at a server 2206 about the operations of a subset of equipment monitored by the IoT devices 2202 may result in the fog network 2220 device the IoT devices 2202, such as particular sensors 2228, needed to answer the query. The data from these sensors 2228 may then be aggregated and analyzed by any combination of the sensors 2228, data aggregators 2226, or gateways 2204, before being sent on by the fog network 2220 to the server 2206 to answer the query. In this example, IoT devices 2202 in the fog network 2220 may select the sensors 2228 used based on the query, such as adding data from flow sensors or temperature sensors. Further, if some of the IoT devices 2202 are not operational, other IoT devices 2202 in the fog network 2220 may provide analogous data, if available.

In other examples, the operations and functionality described herein may be embodied by an IoT or edge compute device in the example form of an electronic processing system, within which a set or sequence of instructions may be executed to cause the electronic processing system to perform any one of the methodologies discussed herein, according to an example embodiment. The device may be an IoT device or an IoT gateway, including a machine embodied by aspects of a personal computer (PC), a tablet PC, a personal digital assistant (PDA), a mobile telephone or smartphone, or any machine capable of executing instructions (sequential or otherwise) that specify actions to be taken by that machine.

Further, while only a single machine may be depicted and referenced in the examples above, such machine shall also be taken to include any collection of machines that individually or jointly execute a set (or multiple sets) of instructions to perform any one or more of the methodologies discussed herein. Further, these and like examples to a processor-based system shall be taken to include any set of one or more machines that are controlled by or operated by a processor, set of processors, or processing circuitry (e.g., a computer) to individually or jointly execute instructions to perform any one or more of the methodologies discussed herein. Accordingly, in various examples, applicable means for processing (e.g., processing, controlling, generating, evaluating, etc.) may be embodied by such processing circuitry.

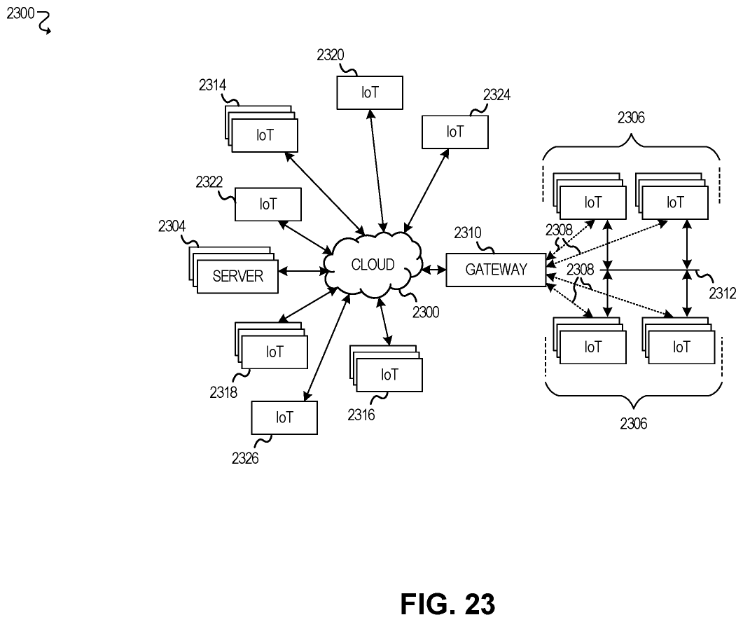

FIG. 23 illustrates a drawing of a cloud computing network, or cloud 2300, in communication with a number of Internet of Things (IoT) devices. The cloud 2300 may represent the Internet, or may be a local area network (LAN), or a wide area network (WAN), such as a proprietary network for a company. The IoT devices may include any number of different types of devices, grouped in various combinations. For example, a traffic control group 2306 may include IoT devices along streets in a city. These IoT devices may include stoplights, traffic flow monitors, cameras, weather sensors, and the like. The traffic control group 2306, or other subgroups, may be in communication with the cloud 2300 through wired or wireless links 2308, such as LPWA links, and the like. Further, a wired or wireless sub-network 2312 may allow the IoT devices to communicate with each other, such as through a local area network, a wireless local area network, and the like. The IoT devices may use another device, such as a gateway 2310 or 2328 to communicate with remote locations such as the cloud 2300; the IoT devices may also use one or more servers 2330 to facilitate communication with the cloud 2300 or with the gateway 2310. For example, the one or more servers 2330 may operate as an intermediate network node to support a local edge cloud or fog implementation among a local area network. Further, the gateway 2328 that is depicted may operate in a cloud-to-gateway-to-many edge devices configuration, such as with the various IoT devices 2314, 2320, 2324 being constrained or dynamic to an assignment and use of resources in the cloud 2300.

Other example groups of IoT devices may include remote weather stations 2314, local information terminals 2316, alarm systems 2318, automated teller machines 2320, alarm panels 2322, or moving vehicles, such as emergency vehicles 2324 or other vehicles 2326, among many others. Each of these IoT devices may be in communication with other IoT devices, with servers 2304, with another IoT fog device or system (not shown, but depicted in FIG. 22), or a combination therein. The groups of IoT devices may be deployed in various residential, commercial, and industrial settings (including in both private or public environments).

As may be seen from FIG. 23, a large number of IoT devices may be communicating through the cloud 2300. This may allow different IoT devices to request or provide information to other devices autonomously. For example, a group of IoT devices (e.g., the traffic control group 2306) may request a current weather forecast from a group of remote weather stations 2314, which may provide the forecast without human intervention. Further, an emergency vehicle 2324 may be alerted by an automated teller machine 2320 that a burglary is in progress. As the emergency vehicle 2324 proceeds towards the automated teller machine 2320, it may access the traffic control group 2306 to request clearance to the location, for example, by lights turning red to block cross traffic at an intersection in sufficient time for the emergency vehicle 2324 to have unimpeded access to the intersection.

Clusters of IoT devices, such as the remote weather stations 2314 or the traffic control group 2306, may be equipped to communicate with other IoT devices as well as with the cloud 2300. This may allow the IoT devices to form an ad-hoc network between the devices, allowing them to function as a single device, which may be termed a fog device or system (e.g., as described above with reference to FIG. 22).

### Computing Devices and Systems

In various embodiments, any of the compute nodes or devices discussed throughout this disclosure may be fulfilled or implemented based on the components depicted in FIGS. 24A and 24B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 24A, an edge compute node 2400 includes a compute engine (also referred to herein as “compute circuitry”) 2402, an input/output (I/O) subsystem 2408, data storage 2410, a communication circuitry subsystem 2412, and, optionally, one or more peripheral devices 2414. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 2400 may be embodied as any type of engine, device, or collection of devices capable of performing various compute functions. In some examples, the compute node 2400 may be embodied as a single device such as an integrated circuit, an embedded system, a field-programmable gate array (FPGA), a system-on-a-chip (SOC), or other integrated system or device. In the illustrative example, the compute node 2400 includes or is embodied as a processor 2404 and a memory 2406. The processor 2404 may be embodied as any type of processor capable of performing the functions described herein (e.g., executing an application). For example, the processor 2404 may be embodied as a multi-core processor(s), a microcontroller, a processing unit, a specialized or special purpose processing unit, or other processor or processing/controlling circuit.

In some examples, the processor 2404 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 2404 may work in coordination with each other to execute many types of operations and instructions within and on behalf of the compute node 2400.

The memory 2406 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 2406 may be integrated into the processor 2404. The memory 2406 may store various software and data used during operation such as one or more applications, data operated on by the application(s), libraries, and drivers.

The compute circuitry 2402 is communicatively coupled to other components of the compute node 2400 via the I/O subsystem 2408, which may be embodied as circuitry and/or components to facilitate input/output operations with the compute circuitry 2402 (e.g., with the processor 2404 and/or the main memory 2406) and other components of the compute circuitry 2402. For example, the I/O subsystem 2408 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 2408 may form a portion of a system-on-a-chip (SoC) and be incorporated, along with one or more of the processor 2404, the memory 2406, and other components of the compute circuitry 2402, into the compute circuitry 2402.

The one or more illustrative data storage devices 2410 may be embodied as any type of devices configured for short-term or long-term storage of data such as, for example, memory devices and circuits, memory cards, hard disk drives, solid-state drives, or other data storage devices. Individual data storage devices 2410 may include a system partition that stores data and firmware code for the data storage device 2410. Individual data storage devices 2410 may also include one or more operating system partitions that store data files and executables for operating systems depending on, for example, the type of compute node 2400.

The communication circuitry 2412 may be embodied as any communication circuit, device, or collection thereof, capable of enabling communications over a network between the compute circuitry 2402 and another compute device (e.g., an edge gateway of an implementing edge computing system). The communication circuitry 2412 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 2412 includes a network interface controller (NIC) 2420, which may also be referred to as a host fabric interface (HFI). The NIC 2420 may be embodied as one or more add-in-boards, daughter cards, network interface cards, controller chips, chipsets, or other devices that may be used by the compute node 2400 to connect with another compute device (e.g., an edge gateway node). In some examples, the NIC 2420 may be embodied as part of a system-on-a-chip (SoC) that includes one or more processors, or included on a multichip package that also contains one or more processors. In some examples, the NIC 2420 may include a local processor (not shown) and/or a local memory (not shown) that are both local to the NIC 2420. In such examples, the local processor of the NIC 2420 may be capable of performing one or more of the functions of the compute circuitry 2402 described herein. Additionally, or alternatively, in such examples, the local memory of the NIC 2420 may be integrated into one or more components of the client compute node at the board level, socket level, chip level, and/or other levels.

Additionally, in some examples, a respective compute node 2400 may include one or more peripheral devices 2414. Such peripheral devices 2414 may include any type of peripheral device found in a compute device or server such as audio input devices, a display, other input/output devices, interface devices, and/or other peripheral devices, depending on the particular type of the compute node 2400. In further examples, the compute node 2400 may be embodied by a respective edge compute node (whether a client, gateway, or aggregation node) in an edge computing system or like forms of appliances, computers, subsystems, circuitry, or other components.

In a more detailed example, FIG. 24B illustrates a block diagram of an example of components that may be present in an edge computing node 2450 for implementing the techniques (e.g., operations, processes, methods, and methodologies) described herein. This edge computing node 2450 provides a closer view of the respective components of node 2400 when implemented as or as part of a computing device (e.g., as a mobile device, a base station, server, gateway, etc.). The edge computing node 2450 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 2450, or as components otherwise incorporated within a chassis of a larger system.

The edge computing device 2450 may include processing circuitry in the form of a processor 2452, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 2452 may be a part of a system on a chip (SoC) in which the processor 2452 and other components are formed into a single integrated circuit, or a single package, such as the Edison™ or Galileo™ SoC boards from Intel Corporation, Santa Clara, California. As an example, the processor 2452 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, California, a MIPS®-based design from MIPS Technologies, Inc. of Sunnyvale, California, an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 2452 and accompanying circuitry may be provided in a single socket form factor, multiple socket form factor, or a variety of other formats, including in limited hardware configurations or configurations that include fewer than all elements shown in FIG. 24B.

The processor 2452 may communicate with a system memory 2454 over an interconnect 2456 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 2458 may also couple to the processor 2452 via the interconnect 2456. In an example, the storage 2458 may be implemented via a solid-state disk drive (SSDD). Other devices that may be used for the storage 2458 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 2458 may be on-die memory or registers associated with the processor 2452. However, in some examples, the storage 2458 may be implemented using a micro hard disk drive (HDD). Further, any number of new technologies may be used for the storage 2458 in addition to, or instead of, the technologies described, such resistance change memories, phase change memories, holographic memories, or chemical memories, among others.

The components may communicate over the interconnect 2456. The interconnect 2456 may include any number of technologies, including industry standard architecture (ISA), extended ISA (EISA), peripheral component interconnect (PCI), peripheral component interconnect extended (PCIx), PCI express (PCIe), or any number of other technologies. The interconnect 2456 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 2456 may couple the processor 2452 to a transceiver 2466, for communications with the connected edge devices 2462. The transceiver 2466 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 2462. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 2466 (or multiple transceivers) may communicate using multiple standards or radios for communications at a different range. For example, the edge computing node 2450 may communicate with close devices, e.g., within about 10 meters, using a local transceiver based on Bluetooth Low Energy (BLE), or another low power radio, to save power. More distant connected edge devices 2462, e.g., within about 50 meters, may be reached over ZigBee© or other intermediate power radios. Both communications techniques may take place over a single radio at different power levels or may take place over separate transceivers, for example, a local transceiver using BLE and a separate mesh transceiver using ZigBee®.

A wireless network transceiver 2466 (e.g., a radio transceiver) may be included to communicate with devices or services in a cloud (e.g., an edge cloud 2495) via local or wide area network protocols. The wireless network transceiver 2466 may be a low-power wide-area (LPWA) transceiver that follows the IEEE 802.15.4, or IEEE 802.15.4 g standards, among others. The edge computing node 2450 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 2466, as described herein. For example, the transceiver 2466 may include a cellular transceiver that uses spread spectrum (SPA/SAS) communications for implementing high-speed communications. Further, any number of other protocols may be used, such as Wi-Fi® networks for medium speed communications and provision of network communications. The transceiver 2466 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 2468 may be included to provide a wired communication to nodes of the edge cloud 2495 or to other devices, such as the connected edge devices 2462 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 2468 may be included to enable connecting to a second network, for example, a first NIC 2468 providing communications to the cloud over Ethernet, and a second NIC 2468 providing communications to other devices over another type of network.

Given the variety of types of applicable communications from the device to another component or network, applicable communications circuitry used by the device may include or be embodied by any one or more of components 2464, 2466, 2468, or 2470. Accordingly, in various examples, applicable means for communicating (e.g., receiving, transmitting, etc.) may be embodied by such communications circuitry.

The edge computing node 2450 may include or be coupled to acceleration circuitry 2464, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 2456 may couple the processor 2452 to a sensor hub or external interface 2470 that is used to connect additional devices or subsystems. The devices may include sensors 2472, such as accelerometers, level sensors, flow sensors, optical light sensors, camera sensors, temperature sensors, global navigation system (e.g., GPS) sensors, pressure sensors, barometric pressure sensors, and the like. The hub or interface 2470 further may be used to connect the edge computing node 2450 to actuators 2474, such as power switches, valve actuators, an audible sound generator, a visual warning device, and the like.

In some optional examples, various input/output (I/O) devices may be present within or connected to, the edge computing node 2450. For example, a display or other output device 2484 may be included to show information, such as sensor readings or actuator position. An input device 2486, such as a touch screen or keypad may be included to accept input. An output device 2484 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 2450. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 2476 may power the edge computing node 2450, although, in examples in which the edge computing node 2450 is mounted in a fixed location, it may have a power supply coupled to an electrical grid, or the battery may be used as a backup or for temporary capabilities. The battery 2476 may be a lithium ion battery, or a metal-air battery, such as a zinc-air battery, an aluminum-air battery, a lithium-air battery, and the like.

A battery monitor/charger 2478 may be included in the edge computing node 2450 to track the state of charge (SoCh) of the battery 2476, if included. The battery monitor/charger 2478 may be used to monitor other parameters of the battery 2476 to provide failure predictions, such as the state of health (SoH) and the state of function (SoF) of the battery 2476. The battery monitor/charger 2478 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 2478 may communicate the information on the battery 2476 to the processor 2452 over the interconnect 2456. The battery monitor/charger 2478 may also include an analog-to-digital (ADC) converter that enables the processor 2452 to directly monitor the voltage of the battery 2476 or the current flow from the battery 2476. The battery parameters may be used to determine actions that the edge computing node 2450 may perform, such as transmission frequency, mesh network operation, sensing frequency, and the like.

A power block 2480, or other power supply coupled to a grid, may be coupled with the battery monitor/charger 2478 to charge the battery 2476. In some examples, the power block 2480 may be replaced with a wireless power receiver to obtain the power wirelessly, for example, through a loop antenna in the edge computing node 2450. A wireless battery charging circuit, such as an LTC4020 chip from Linear Technologies of Milpitas, California, among others, may be included in the battery monitor/charger 2478. The specific charging circuits may be selected based on the size of the battery 2476, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 2458 may include instructions 2482 in the form of software, firmware, or hardware commands to implement the techniques described herein. Although such instructions 2482 are shown as code blocks included in the memory 2454 and the storage 2458, it may be understood that any of the code blocks may be replaced with hardwired circuits, for example, built into an application specific integrated circuit (ASIC).

In an example, the instructions 2482 provided via the memory 2454, the storage 2458, or the processor 2452 may be embodied as a non-transitory, machine-readable medium 2460 including code to direct the processor 2452 to perform electronic operations in the edge computing node 2450. The processor 2452 may access the non-transitory, machine-readable medium 2460 over the interconnect 2456. For instance, the non-transitory, machine-readable medium 2460 may be embodied by devices described for the storage 2458 or may include specific storage units such as optical disks, flash drives, or any number of other hardware devices. The non-transitory, machine-readable medium 2460 may include instructions to direct the processor 2452 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 2482 on the processor 2452 (separately, or in combination with the instructions 2482 of the machine readable medium 2460) may configure execution or operation of a trusted execution environment (TEE) 2490. In an example, the TEE 2490 operates as a protected area accessible to the processor 2452 for secure execution of instructions and secure access to data. Various implementations of the TEE 2490, and an accompanying secure area in the processor 2452 or the memory 2454 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 2450 through the TEE 2490 and the processor 2452.

### Machine-Readable Medium and Distributed Software Instructions

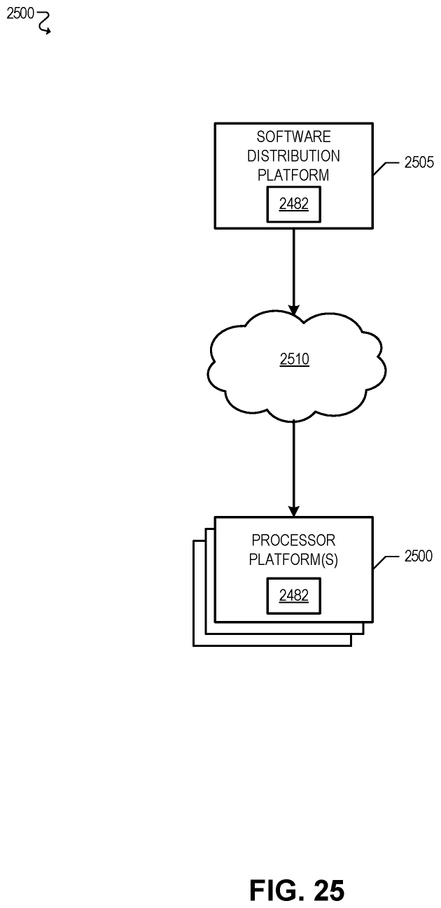

FIG. 25 illustrates an example software distribution platform 2505 to distribute software, such as the example computer readable instructions 2482 of FIG. 24B, to one or more devices, such as example processor platform(s) 2500 and/or example connected edge devices, gateways, and/or sensors described throughout this disclosure. The example software distribution platform 2505 may be implemented by any computer server, data facility, cloud service, etc., capable of storing and transmitting software to other computing devices (e.g., third parties, example connected edge devices described throughout this disclosure). Example connected edge devices may be customers, clients, managing devices (e.g., servers), third parties (e.g., customers of an entity owning and/or operating the software distribution platform 2505). Example connected edge devices may operate in commercial and/or home automation environments. In some examples, a third party is a developer, a seller, and/or a licensor of software such as the example computer readable instructions 2482 of FIG. 24B. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

In the illustrated example of FIG. 25, the software distribution platform 2505 includes one or more servers and one or more storage devices. The storage devices store the computer readable instructions 2482. The one or more servers of the example software distribution platform 2505 are in communication with a network 2510, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 2482 from the software distribution platform 2505. For example, the software, which may correspond to the example computer readable instructions described throughout this disclosure, may be downloaded to the example processor platform(s) 2500 (e.g., example connected edge devices), which is/are to execute the computer readable instructions 2482 to implement the functionality described throughout this disclosure. In some examples, one or more servers of the software distribution platform 2505 are communicatively connected to one or more security domains and/or security devices through which requests and transmissions of the example computer readable instructions 2482 must pass. In some examples, one or more servers of the software distribution platform 2505 periodically offer, transmit, and/or force updates to the software (e.g., the example computer readable instructions 2482 of FIG. 24B) to ensure improvements, patches, updates, etc. are distributed and applied to the software at the end user devices.

In the illustrated example of FIG. 25, the computer readable instructions 2482 are stored on storage devices of the software distribution platform 2505 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 2482 stored in the software distribution platform 2505 are in a first format when transmitted to the example processor platform(s) 2500. In some examples, the first format is an executable binary in which particular types of the processor platform(s) 2500 can execute. However, in some examples, the first format is uncompiled code that requires one or more preparation tasks to transform the first format to a second format to enable execution on the example processor platform(s) 2500. For instance, the receiving processor platform(s) 2500 may need to compile the computer readable instructions 2482 in the first format to generate executable code in a second format that is capable of being executed on the processor platform(s) 2500. In still other examples, the first format is interpreted code that, upon reaching the processor platform(s) 2500, is interpreted by an interpreter to facilitate execution of instructions.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

### Examples

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes a method of advertising a wireless sensor network to sensor devices, comprising: sending a plurality of advertising beacons on an advertising channel, wherein the advertising beacons are to enable the sensor devices to join the wireless sensor network, and wherein each advertising beacon indicates: a primary channel associated with the wireless sensor network; and a time offset to a next synchronization beacon to be sent on the primary channel; and sending a plurality of synchronization beacons on the primary channel, wherein each synchronization beacon is sent at the time offset indicated in one or more of the advertising beacons.

Example 2 includes the method of Example 1, wherein the method is performed by a gateway, gateway device, or gateway node.

Example 3 includes a method of joining a wireless sensor network, comprising: listening on an advertising channel associated with the wireless sensor network; receiving an advertising beacon on the advertising channel, wherein the advertising beacon indicates: a primary channel associated with the wireless sensor network; and a time offset to a next synchronization beacon to be sent on the primary channel; extracting the primary channel and the time offset from the advertising beacon; listening on the primary channel near a time indicated by the time offset; receiving a synchronization beacon on the primary channel at the time indicated by the time offset; and sending a contention request on the primary channel to join the wireless sensor network.

Example 4 includes the method of Example 1, wherein the method is performed by a sensor, sensor tag, sensor device, or sensor node.

Example 5 includes the method of any of Examples 1-4, wherein the advertising channel and the primary channel are radio frequency (RF) channels.

Example 6 includes the method of any of Examples 1-5, wherein: the advertising channel is known to at least some of the sensor devices; and the primary channel is unknown to at least some of the sensor devices prior to receiving an advertising beacon on the advertising channel.

Example 7 includes the method of any of Examples 1-6, wherein the advertising beacons are transmitted more frequently than the synchronization beacons.

Example 8 includes the method of any of Examples 1-7, wherein each advertising beacon further indicates: a slot availability, wherein the slot availability indicates whether a slot is available to join the wireless sensor network; or an authentication key for joining the wireless sensor network.

Example 9 includes a method of managing requests to join a wireless sensor network, comprising: sending a synchronization beacon on a channel associated with the wireless sensor network, wherein the synchronization beacon indicates: a time offset to a contention period in a current frame on the channel; and a number of contention slots in the contention period; and receiving contention requests on the channel from sensor devices in a plurality of contentions slots of the current frame, wherein each contention request is received from a corresponding sensor device in a corresponding contention slot assigned from the plurality of contention slots.

Example 10 includes the method of Example 9, wherein the method is performed by a gateway, gateway device, or gateway node.

Example 11 includes a method of requesting to join a wireless sensor network, comprising: receiving a synchronization beacon on a channel associated with the wireless sensor network, wherein the synchronization beacon indicates: a time offset to a contention period in a current frame on the channel; and a number of contention slots in the contention period; determining an assigned contention slot based on the number of contention slots and a device identifier; and sending a contention request on the channel to join the wireless sensor network, wherein the contention request is sent in the assigned contention slot of the current frame.

Example 12 includes the method of Example 11, wherein the method is performed by a sensor, sensor tag, sensor device, or sensor node.

Example 13 includes a method of collecting logged sensor data captured by a sensor device during a loss of connectivity with a wireless senser network, comprising: receiving a request from the sensor device to report the logged sensor data, wherein the logged sensor data is captured by the sensor device during the loss of connectivity with the wireless sensor network; sending one or more logged data beacons to the sensor device based on the request; receiving at least some of the logged sensor data from the sensor device in response to each logged data beacon.

Example 14 includes the method of Example 13, wherein the method is performed by a gateway, gateway device, or gateway node.

Example 15 includes a method of logging and reporting sensor data captured during a loss of connectivity with a wireless sensor network, comprising: detecting the loss of connectivity with the wireless sensor network; logging sensor data captured during the loss of connectivity; listening for synchronization beacons to resynchronize with the wireless sensor network; receiving a synchronization beacon; sending a request to report the logged sensor data; receiving one or more logged data beacons; sending at least some of the logged sensor data in response to each of the logged data beacons.

Example 16 includes the method of Example 15, wherein the method is performed by a sensor, sensor tag, sensor device, or sensor node.

Example 17 includes a method of synchronization for a wireless sensor network, comprising: sending a plurality of synchronization beacons on the channel, wherein the synchronization beacons are to enable sensor devices to synchronize with the wireless sensor network; and sending a plurality of nano beacons on the channel after each synchronization beacon, wherein the nano beacons are to enable the sensor devices to resynchronize with the wireless sensor network after a loss of connectivity, and wherein each nano beacon indicates a time offset to a next synchronization beacon to be sent on the channel.

Example 18 includes the method of Example 17, wherein the method is performed by a gateway, gateway device, or gateway node.

Example 19 includes a method of synchronizing with a wireless sensor network, comprising: receiving a first synchronization beacon on a channel associated with the wireless sensor network, wherein the first synchronization beacon corresponds to a first frame on the channel; sending a first sensor data sample in an assigned timeslot in the first frame; determining that a second synchronization beacon is not received on the channel at an expected time; listening for nano beacons on the channel; receiving a nano beacon on the channel, wherein the nano beacon indicates a time offset to a next synchronization beacon to be sent on the channel; extracting the time offset from the nano beacon; listening on the channel near a time indicated by the time offset; and receiving a third synchronization beacon on the channel at the time indicated by the time offset.

Example 20 includes the method of Example 19, wherein the method is performed by a sensor, sensor tag, sensor device, or sensor node.

Example 21 includes the method of any of Examples 17-20, wherein nano beacons are transmitted on the channel more frequently than synchronization beacons.

Example 22 includes a method of detecting a flight state of an aircraft, comprising: obtaining, from an acceleration sensor, a set of acceleration measurements captured during a current time window; obtaining, from a pressure sensor, a set of pressure measurements captured during the current time window; and detecting, based on the acceleration measurements and the pressure measurements, the flight state of the aircraft during the current time window.

Example 23 includes the method of Example 22, wherein the flight state is takeoff, landing, cruise, or idle.

Example 24 includes the method of any of Examples 22-23, further comprising: disabling or enabling radio frequency transmissions on an electronic device on the aircraft based on the flight state.

Example 25 includes the method of Example 24, wherein: the electronic device comprises an asset tracking device, wherein the asset tracking device comprises the acceleration sensor and the pressure sensor; and the method is performed by the asset tracking device;

Example 26 includes the method of Example 24, wherein the electronic device comprises a user device.

Example 27 includes a method of asset tracking, comprising: capturing, via one or more sensors, a first set of asset attributes associated with an asset, wherein the first set of asset attributes are captured at a point of origin of the asset; registering the first set of asset attributes in a blockchain; capturing, via at least some of the one or more sensors, one or more second sets of asset attributes associated with the asset, wherein the one or more second sets of asset attributes are captured at one or more checkpoints; registering the one or more second sets of asset attributes in the blockchain; capturing, via at least some of the one or more sensors, a third set of asset attributes associated with the asset, wherein the third set of asset attributes are captured at a destination of the asset; and registering the third set of asset attributes in the blockchain.

Example 28 includes the method of Example 27, wherein the first set, the one or more second sets, or the third set of asset attributes comprise one or more of: location; temperature; pressure; elevation; altitude; shock; tilt; or a physical characteristic.

Example 29 includes the method of any of Examples 27-28, further comprising: evaluating the one or more second sets of asset attributes and the third set of asset attributes; detecting, based on the evaluation, one or more violations of one or more shipping requirements for the asset; and registering the one or more violations in the blockchain.

Example 30 includes the method of any of Examples 27-29, further comprising: determining whether one or more delivery requirements are satisfied for the asset; and upon determining that the one or more delivery requirements are satisfied, registering a signature in the blockchain to indicate proof of delivery.

Example 31 includes the method of any of Examples 27-30, wherein the method is performed by an asset tracking device.

Example 32 includes a method of authentication for a wireless sensor network, comprising: receiving, from a sensor device, a contention request to join the wireless sensor network, wherein the contention request comprises: a device identifier for the sensor device; and a challenge response for authenticating the sensor device; sending, to an authentication server, an add request to add the sensor device to the wireless sensor network, wherein the add request comprises the device identifier and the challenge response; receiving, from the authentication server, approval to add the sensor device to the wireless sensor network; and sending, to the sensor device, an association beacon for joining the wireless sensor network, wherein the association beacon indicates an assigned timeslot for transmissions from the sensor device.

Example 33 includes the method of Example 32, wherein the authentication server comprises a cloud-based server associated with the wireless sensor network.

Example 34 includes the method of Example 33, wherein the cloud-based server comprises a gateway virtual appliance.

Example 35 includes the method of any of Examples 32-34, wherein the method is performed by a gateway, gateway device, or gateway node.

Example 36 includes a method of authenticating with a wireless sensor network, comprising: sending, to a gateway device associated with the wireless sensor network, a contention request to join the wireless sensor network, wherein the contention request comprises: a device identifier for the sensor device; and a challenge response for authenticating the sensor device; and receiving, from the gateway device, an association beacon for joining the wireless sensor network, wherein the association beacon indicates an assigned timeslot for transmissions from the sensor device.

Example 37 includes the method of Example 36, wherein the method is performed by a sensor, sensor tag, sensor device, or sensor node.

Example 38 includes the method of any of Examples 1-37, wherein communication is performed using one or more of the following: IEEE 802.11; IEEE 802.15.4; Matter; Thread; Bluetooth Low Energy (BLE); or an Open Connectivity Foundation (OCF) specification.

Example 39 includes the method of any of Examples 1-38, wherein the method is performed by a sensor, sensor tag, sensor device, or sensor node.

Example 40 includes the method of any of Examples 1-38, wherein the method is performed by a gateway, gateway device, or gateway node.

Example 41 includes the method of any of Examples 1-38, wherein the method is performed by a client, client device, or client node.

Example 42 includes the method of any of Examples 1-38, wherein the method is performed by a server, server device, or server node.

Example 43 includes the method of any of Examples 1-38, wherein the method is performed by an asset tracker, asset tracker device, asset tracking device, asset tracker node, or asset tracking node.

Example 44 includes the method of any of Examples 1-38, wherein the method is performed by a smart camera.

Example 45 includes the method of any of Examples 1-38, wherein the method is performed by a user device.

Example 46 includes the method of Example 45, wherein the user device comprises a mobile phone, a tablet, a laptop, or a wearable device.

Example 47 includes a gateway, gateway device, or gateway node comprising circuitry to implement the method of any of Examples 1-38.

Example 48 includes a sensor, sensor tag, sensor device, or sensor node comprising circuitry to implement the method of any of Examples 1-38.

Example 49 includes a server, server device, or server node comprising circuitry to implement the method of any of Examples 1-38.

Example 50 includes a client, client device, or client node comprising circuitry to implement the method of any of Examples 1-38.

Example 51 includes an asset tracking device comprising circuitry to implement the method of any of Examples 1-38.

Example 52 includes a smart camera comprising circuitry to implement the method of any of Examples 1-38.

Example 53 includes a user device comprising circuitry to implement the method of any of Examples 1-38.

Example 54 includes the user device of Example 53, wherein the user device comprises a mobile phone, a tablet, a laptop, or a wearable device.

Example 55 includes a wireless communication system comprising nodes to implement the method of any of Examples 1-38.

Example 56 includes a radio access network comprising nodes to implement the method of any of Examples 1-38.

Example 57 includes an access point comprising circuitry to implement the method of any of Examples 1-38.

Example 58 includes a base station comprising circuitry to implement the method of any of Examples 1-38.

Example 59 includes a cloud computing system, cloud server, or cloud node comprising circuitry to implement the method of any of Examples 1-38.

Example 60 includes an edge computing system, edge server, or edge node comprising circuitry to implement the method of any of Examples 1-38.

Example 61 includes an edge cloud system, edge cloud server, or edge cloud node comprising circuitry to implement the method of any of Examples 1-38.

Example 62 includes a multi-access edge computing (MEC) system, MEC server, or MEC node comprising circuitry to implement the method of any of Examples 1-38.

Example 63 includes a mobile device or user equipment device comprising circuitry to implement the method of any of Examples 1-38.

Example 64 includes a client computing device or end user device comprising circuitry to implement the method of any of Examples 1-38.

Example 65 includes an apparatus comprising means to implement the method of any of Examples 1-38.

Example 66 includes an apparatus comprising logic, modules, or circuitry to implement the method of any of Examples 1-38.

Example 67 includes an apparatus comprising processing circuitry, interface circuitry, and communication circuitry to implement the method of any of Examples 1-38.

Example 68 includes an apparatus comprising: one or more processors and one or more computer-readable media comprising instructions that, when executed by the one or more processors, cause the one or more processors to implement the method of any of Examples 1-38.

Example 69 includes one or more non-transitory computer-readable media comprising instructions to cause an electronic device, upon execution of the instructions by one or more processors of the electronic device, to implement the method of any of Examples 1-38.

Example 70 includes a computer program comprising instructions, wherein execution of the program by a processing element is to cause the processing element to implement the method of any of Examples 1-38.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

1-70. (canceled)

71. A device, comprising:
communication circuitry; and
processing circuitry to:
send, via the communication circuitry, a plurality of advertising beacons on an advertising channel of a wireless network, wherein the advertising beacons are to be received by client devices listening on the advertising channel, and wherein individual advertising beacons indicate:
a primary channel of the wireless network; and
a time offset to a next synchronization beacon to be sent on the primary channel; and
send, via the communication circuitry, a plurality of synchronization beacons on the primary channel, wherein individual synchronization beacons are sent at the time offset indicated in one or more of the advertising beacons.

72. The device of claim 71, wherein the client devices are sensor devices, wherein individual sensor devices comprise one or more sensors.

73. The device of claim 72, wherein at least one of the sensor devices is:
a sensor tag;
a radio frequency identification tag; or
an asset tracking device.

74. The device of claim 71, wherein the device is a gateway device associated with the wireless network.

75. The device of claim 71, wherein the processing circuitry is further to:
receive, via the communication circuitry, a contention request to join the wireless network, wherein the contention request is received on the primary channel from one of the client devices.

76. The device of claim 71, wherein:
the advertising channel is known to at least some of the client devices; and
the primary channel is unknown to at least some of the client devices prior to receiving an advertising beacon on the advertising channel.

77. The device of claim 71, wherein the advertising beacons are transmitted more frequently than the synchronization beacons.

78. The device of claim 71, wherein individual advertising beacons further indicate:
a slot availability, wherein the slot availability indicates whether a slot is available to join the wireless network; or
an authentication key for joining the wireless network.

79. At least one non-transitory machine-readable storage medium having instructions stored thereon, wherein the instructions, when executed on processing circuitry, cause the processing circuitry to:
send, via communication circuitry, a plurality of advertising beacons on an advertising channel of a wireless network, wherein the advertising beacons are to be received by client devices listening on the advertising channel, and wherein individual advertising beacons indicate:
a primary channel of the wireless network; and
a time offset to a next synchronization beacon to be sent on the primary channel; and
send, via the communication circuitry, a plurality of synchronization beacons on the primary channel, wherein individual synchronization beacons are sent at the time offset indicated in one or more of the advertising beacons.

80. The storage medium of claim 79, wherein the client devices are sensor devices, wherein individual sensor devices comprise one or more sensors.

81. The storage medium of claim 80, wherein at least one of the sensor devices is:
a sensor tag;
a radio frequency identification tag; or
an asset tracking device.

82. The storage medium of claim 79, wherein the instructions further cause the processing circuitry to:
receive, via the communication circuitry, a contention request to join the wireless network, wherein the contention request is received on the primary channel from one of the client devices.

83. The storage medium of claim 79, wherein:
the advertising channel is known to at least some of the client devices; and
the primary channel is unknown to at least some of the client devices prior to receiving an advertising beacon on the advertising channel.

84. The storage medium of claim 79, wherein the advertising beacons are transmitted more frequently than the synchronization beacons.

85. The storage medium of claim 79, wherein individual advertising beacons further indicate:
a slot availability, wherein the slot availability indicates whether a slot is available to join the wireless network; or
an authentication key for joining the wireless network.

86. A method, comprising:
sending a plurality of advertising beacons on an advertising channel of a wireless network, wherein the advertising beacons are to be received by client devices listening on the advertising channel, and wherein individual advertising beacons indicate:
a primary channel of the wireless network; and
a time offset to a next synchronization beacon to be sent on the primary channel; and
sending a plurality of synchronization beacons on the primary channel, wherein individual synchronization beacons are sent at the time offset indicated in one or more of the advertising beacons.

87. The method of claim 86, wherein the client devices are sensor devices, wherein individual sensor devices comprise one or more sensors.

88. The method of claim 86, further comprising:
receiving, on the primary channel, a contention request to join the wireless network from one of the client devices.

89. The method of claim 86, wherein:
the advertising channel is known to at least some of the client devices; and
the primary channel is unknown to at least some of the client devices prior to receiving an advertising beacon on the advertising channel.

90. The method of claim 86, wherein the advertising beacons are transmitted more frequently than the synchronization beacons.
